(19) United States
(12) Patent Application Publication
(10) Pub. No.: US 2022/0016587 A1
(43) Pub. Date: Jan. 20, 2022

(54) Systems, Methods, and Apparatus for Utilizing a Resuspension Tank

(71) Applicant: University of Baltimore, Baltimore, MD (US)

(72) Inventor: Elka T. Porter, Crofton, MD (US)

(73) Assignee: University of Baltimore, Baltimore, MD (US)

(21) Appl. No.: 17/479,514

(22) Filed: Sep. 20, 2021

Related U.S. Application Data
(63) Continuation of application No. 16/647,165, filed on Mar. 13, 2020.
(60) Provisional application No. 62/867,406, filed on Jun. 27, 2019.
(60) Provisional application No. 62/741,895, filed on Oct. 5, 2018.

(51) Int. Cl. B01F 7/00; B01F 3/00; B01F 7/20; B01F 15/00; C02F 3/30; C02F 3/32

(52) U.S. Cl. CPC B01F 7/00208; B01F 3/00; B01F 7/20; B01F 2015/00636; C02F 3/302; C02F 3/327; B01F 2003/0028; B01F 15/00435

(57) ABSTRACT

Systems, methods and apparatus for Shear TUrbulence Resuspension Mesocosm (STURM) tanks, with high instantaneous bottom shear stress and realistic water column mixing. The tanks can be programmed to produce tidal or episodic sediment resuspension for extended time periods, over muddy sediments with a variety of infaunal benthic organisms. A resuspension paddle produces substantially uniform bottom shear stress across the sediment surface while gently mixing a 1 m deep overlying water column. The STURM tanks can be programmed to different magnitudes, frequencies, and durations of bottom shear stress and thus resuspension with proportional water column turbulence levels over a wide range of mixing settings for benthic-pelagic coupling experiments.

### CROSS-REFERENCE TO RELATED APPLICATIONS

This application is a continuation of U.S. patent application Ser. No. 16/647,165 (filed on Mar. 13, 2020), which is a National Stage Entry of International Patent Application No. PCT/US2019/054601 (filed on Oct. 4, 2019), which claims the benefit of US Provisional Patent Application Nos. 62/741,895 (filed on Oct. 5, 2018) and 62/867,406 (filed on Jun. 27, 2019), the disclosures of which are incorporated herein by reference in their entireties.

### FIELD OF THE DISCLOSURE

The present disclosure relates to Shear TUrbulence Resuspension Mesocosm (STURM) tanks, with high instantaneous bottom shear stress and realistic water column mixing in a single system, thereby allowing realistic benthic-pelagic coupling studies with sediment resuspension.

### BACKGROUND

Benthic and pelagic processes are closely coupled in shallow-water estuarine and marine environments and in lakes. Benthic-pelagic coupling processes include the cycling of particles and solutes between a water column and sediments through particulate water column production, sediment resuspension and deposition, burial, remineralization and regeneration of solutes, and pore water exchange. Factors that influence these processes affect nutrient and contaminant cycling, ecosystem dynamics, community composition and faunal abundance, and overall water quality. Benthic and pelagic processes are often linked through indirect and non linear processes that are difficult to study or predict with conventional approaches.

### SUMMARY

Embodiments described herein are directed to systems, methods and apparatus for Shear TUrbulence Resuspension Mesocosm (STURM) tanks, with high instantaneous bottom shear stress and realistic water column mixing. The 1 m³ tanks can be programmed to produce tidal or episodic sediment resuspension for extended time periods (e.g., 4 weeks), over muddy sediments with a variety of infaunal benthic organisms. A resuspension paddle produces substantially uniform bottom shear stress across the sediment surface while gently mixing a 1 m deep overlying water column. The STURM tanks can be programmed to different magnitudes, frequencies, and durations of bottom shear stress (and thus resuspension) with proportional water column turbulence levels over a wide range of mixing settings for benthic-pelagic coupling experiments.

One embodiment is directed to a vessel having a predetermined volume of water contained in the vessel and a resuspension mechanism disposed in the vessel configured to move in a pattern to produce water column mixing, an energy dissipation rate, RMS turbulent velocity and bottom shear stress forces relative to a layer of sediment in a lower portion of the vessel.

### BRIEF DESCRIPTION OF THE DRAWINGS

The accompanying drawings, which are incorporated in and constitute a part of this specification, illustrate embodiments of the present disclosure and, together with a general description given above, and the detailed description given below, serve to explain the principles of the present disclosure.

FIG. 1 shows a representation of benthic-pelagic coupling processes.

FIG. 2 shows an example of a STURM tank system according to an embodiment of the disclosure.

FIG. 3 shows an example of a status page according to an embodiment of the disclosure.

FIGS. 4A and 4B show a representation of a total suspended solids concentration in a resuspension tank and non-resuspension tank, respectively.

FIG. 5 shows an illustration of dissolved oxygen concentrations in the resuspension tanks and the non-resuspension tanks.

FIG. 6 shows an illustration of nitrite and nitrate concentrations in the resuspension tanks and the non-resuspension tanks.

FIGS. 7A-7C show an illustration of irradiance in the resuspension tanks and the non-resuspension tanks, biogeochemical dissolved oxygen fluxes and ammonium fluxes.

FIG. 8 shows an illustration of synthesis with non-resuspension and with resuspension with biodeposit additions.

FIG. 9 shows a graphic illustration of results of total suspended solids concentrations.

FIG. 10 shows a graphic illustration of results of dissolved oxygen concentrations.

FIG. 11 shows a graphic illustration of results of bulk settling speed.

FIGS. 12A, 12B and 12C show graphic illustrations of nitrate plus nitrite concentrations, total phytoplankton carbon, and total zooplankton carbon, respectively.

FIGS. 13A and 13B show graphic illustrations of Skeletonema costatum biomass and chain length, respectively.

FIGS. 14A and 14B show representations of synthesis in a resuspension system, and synthesis in a resuspension system with biodeposits, respectively.

FIGS. 15A and 15B illustrate examples of a resuspension mechanism according to some of the embodiments disclosed herein.

FIGS. 16A-F show graphical representations of water column turbulence levels and bottom shear stress over a range of mixing settings in STURM tank.

FIG. 17 shows a representation of performance of the STURM tank over a range of mixing settings.

FIGS. 18 A-I show water column RMS turbulent velocity, energy dissipation and flow vectors at various mixing settings.

FIG. 19 depicts a view into a STURM tank, in accordance with an embodiment of the present disclosure.

It should be understood that the appended drawings are not necessarily to scale, presenting a somewhat simplified representation of various features illustrative of the basic principles of the disclosure. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The present disclosure will now be described more fully hereinafter with reference to the accompanying drawings, in which preferred embodiments are shown. This disclosure may, however, be embodied in many different forms and should not be construed as limited to the embodiments set forth herein. Rather, these embodiments are provided so that this disclosure will be thorough and complete, and will fully convey the scope to those skilled in the art.

A Shear TUrbulence Resuspension Mesocosm (STURM) with realistic shear stress and water column turbulence was designed and a description of the performance of the resuspension mesocosm over a wide range of mixing settings is provided.

Shear TUrbulence Resuspension Mesocosm (STURM) tanks, with high instantaneous bottom shear stress and realistic water column mixing in a single system, allow realistic benthic-pelagic coupling studies with sediment resuspension. The 1 m³ tanks may be programmed to produce tidal or episodic sediment resuspension for extended time periods (e.g., 4 weeks), over muddy sediments with a variety of infaunal benthic organisms. A resuspension paddle produces substantially uniform bottom shear stress across the sediment surface while gently mixing a 1 m deep overlying water column. The STURM tanks can be programmed to different magnitudes, frequencies, and durations of bottom shear stress (and thus resuspension) with proportional water column turbulence levels over a wide range of mixing settings for benthic-pelagic coupling experiments. Over ten STURM calibration settings, RMS turbulent velocity ranged from approximately 0.26 to approximately 4.52 cm s⁻¹, energy dissipation rate from approximately 0.0016 to approximately 2.65 cm² s⁻³, the average bottom shear stress from approximately 0.0035 to approximately 0.19 Pa, and the instantaneous maximum bottom shear stress from approximately 0.07 to approximately 1.7 Pa. Eight 4-week benthic-pelagic coupling ecosystem experiments with tidal resuspension and stepwise erosion experiments were performed (both with and without infaunal bivalves).

These experiments were carried out on oyster biodeposit resuspension, mimicked storms overlain on tidal resuspension, and studied the effects of varying frequency and duration of resuspension on sedimentary contaminant release. The large size of the tanks allows water quality and particle measurements using standard oceanographic instrumentation and does not limit light, an important ecosystem consideration. The realistic scale and complexity of the contained ecosystems revealed indirect feedbacks and responses that are not observable in smaller, less complex experimental systems.

As apparent to those in the relevant art, exemplifying these processes in the laboratory is often difficult and mixing is typically not measured. The fact that mixing is not typically measured is troubling because mixing is a significant parameter for water column ecosystem processes and with bottom shear stress, mixing is important for benthic-pelagic coupling processes. Variables of special importance for properly mimicking environmental conditions are shear stress, RMS turbulent velocity, and energy dissipation rate and the ratio of RMS turbulent velocity to shear velocity.

Bottom shear stress (fluid shear force per unit bottom area), in interaction with the bed properties, organisms, and microphytobenthos, determines the frequency and magnitude of sediment resuspension and induces temporal changes in seston quantity and quality. Bottom shear stress is mediated by tides, waves or wave-current interactions that includes storm events. Resuspension affects water turbidity, bacterial growth, carbon cycling, and oxygen dynamics. In addition, resuspension affects water column nutrient dynamics via porewater release and nutrient release from particles. Furthermore, resuspension affects contaminant dynamics.

Ecosystem field studies are often highly variable and may involve costly long-term monitoring to distinguish treatment effects from natural variability. In addition, while resuspension is frequently measured in the field, it is challenging to track material flows and system feedbacks in ecosystem field studies.

In contrast, most experiments that include sediment resuspension are conducted in small-scale erosion devices, such as various designs of benthic chambers, however, results from small-scale studies are difficult to scale up to whole ecosystems.

A benthic water column simulator may be used for short-term aquatic resuspension-deposition cycling studies. In other approaches, small incubation bottles may be shaken to mimic sediment resuspension or a horizontal shaker may be used. These small scale (bench-top) studies address specific interactions in a detailed manner but do not capture direct and indirect links and feedback between bottom sediments and the deeper, more quiescent water column that overlies the benthic environment in most natural aquatic environments. They are also mostly short-term studies. Experiments on field cores can also provide snapshots of physical-biological interactions at different sites and times, but the effects of intermittent events such as storms or persistent events such as tidal cycles cannot be adequately captured. Moreover, there is an issue that the surface floc (or “fluff”) layer in field cores can be disrupted when cores are collected and transferred to the laboratory, which then affects surface exchanges.

In between the small-scale studies and the field ecosystem approach lie studies involving mesoscale experimental ecosystems, or mesocosms. However, bottom shear at the sediment-water interface of mesocosms is usually unrealistically low, which produces artifacts and compromises the validity of the experiments and the results. Mesocosm experiments in single tanks or large bags typically are conducted without sediment resuspension. Successful attempts to induce resuspension in mesocosms or large bag mesocosms for ecosystem experiments have not been sustained over long periods, and water column turbulence and bottom shear levels were not measured. Resuspension over 35-63 d in mesocosms has been produced using submersible pumps running 24 hours a day without mixing and bottom shear stress being measured. The use of a submersible pump introduces a host of problems that render such experiments virtually worthless.

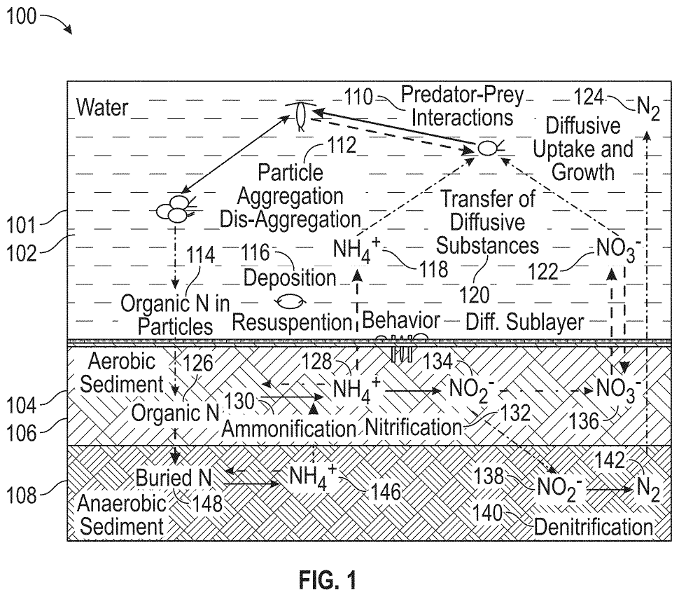

FIG. 1 shows a representation 100 of benthic-pelagic coupling processes. The tank 101 includes water region 102 and sediment region 104. Sediment region 104 has aerobic 106 and anaerobic 108 portions.

Water region 102 has organic nitrogen (N) in particles 114. FIG. 1 also shows particle aggregation/disaggregation as affected by energy dissipation rate 112, deposition/resuspension 116, NH₄⁺ 118, transfer of diffusive substance as affected by RMS turbulent velocity 120, NO₃⁻ 122 into diffusive uptake and growth to predator prey interactions as affected by energy dissipation rate 110.

In the aerobic sediment layer, organic N 126, NH₄⁺ 128, NO₂⁻ 134 and NO₃⁻ 136 are shown. Also shown are ammonification 130 and nitrification 132.

Some of the NO₂⁻ 134 is denitrified in the anaerobic sediment 108 as shown by NO₂⁻ 138, to N₂ gas 142 and N₂ 124 in the water region 102 which is removed from the system. Also shown in the anaerobic layer are buried N 148 and NH₄⁺ 146 as well as denitrification 140.

An important scale for quantifying benthic turbulence is shear (or ‘friction’) velocity u_{*} (cm s⁻¹), which expresses the boundary-layer shear stress as a velocity scale

$${u}_{*} = √ \frac{τ b}{ρ}$$

where τ_{b} is bottom shear stress (dynes cm⁻²) and p is the density of water (g cm⁻³). Shear stress in dynes cm⁻² multiplied by 0.1 equals shear stress in Pascal (Pa), the most commonly used unit. Shear velocity ranges from approximately 0.1 to approximately 1 cm s⁻¹ on the continental shelf and in microtidal estuarine benthic boundary-layers, and from approximately 1 to approximately 10 cm s⁻¹ in macrotidal estuarine benthic boundary-layers.

Two important criteria for quantifying water column turbulence are RMS turbulent velocity q and turbulence energy dissipation rate E. RMS turbulent velocity scales as the shear velocity in boundary layer flows. However, it is difficult to produce high near-bottom RMS turbulent velocity and realistic water column turbulent dissipation rates in the same experimental ecosystem as the variables typically do not scale linearly together.

RMS turbulent velocity and energy dissipation rate are related non-linearly as:

$$ɛ = \frac{\overline{{q}^{3}}}{l}$$

where l is the eddy length scale. Energy dissipation rate (cm² s⁻³) is especially difficult to keep within a realistic range because the eddy length scale in experimental ecosystems is much smaller than in nature, thus, energy dissipation rate quickly becomes artificially large in experimental ecosystems. Energy dissipation rate controls small-scale fluid shear, so it can affect particle aggregation and disaggregation and planktonic contact rates; e.g., between copepods and their food particles. Thus, energy dissipation rates would be desirable to be mimicked realistically in ecosystem experiments and in experiments with resuspension to allow the proper study of ecosystem processes and interactions.

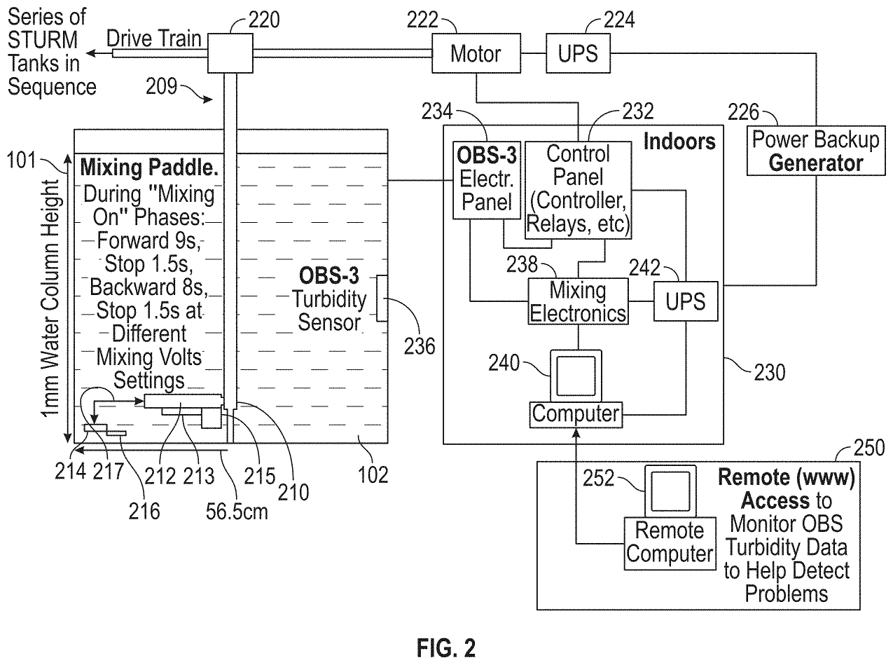

FIG. 2 shows an example of a STURM tank system according to an embodiment of the disclosure. The tank 101 has water region 102 and sediment region (not shown in FIG. 2). Resuspension mechanism 209 is attached to drive train 220, which may be considered part of the resuspension mechanism 209, as well as motor 222, UPS 224 and module or apparatus 230, which may be in a separate room, or remote location, for example.

The resuspension mechanism 209, which may suitably be a paddle, has a shaft 210 and horizontal portions 212, 214 and 216, each with dimensions, as described herein. The resuspension mechanism, while described as a paddle for descriptive purposes, includes members and portions as described herein. Thus, while the term paddle is an over-simplification, as described herein the term paddle includes the various height adjustment features, flap feature, perforated portion, aluminum arm, two substantially horizontal members and spacer member between the two substantially horizontal members. For example, also shown are arm portion 217, flap 215 and perforated portion 213. In the tank 101 are one or more sensors, shown generally as turbidity sensor 236. The paddle 209 may be operated in a desired mode or modes. One suitable mode is 9 seconds forward motion, 1.5 seconds stop, 8 seconds backward motion, 1.5 seconds stop and then repeated. The forward/backward motion is set to a desired, calibrated, paddle rotation rate per minute (RPM). The resuspension mechanism 209, shown as a paddle, may also have substantially horizontal members 212, 214 and 216 which are designed and dimensioned to interact with the sediment layer.

Drive train 220, motor 222 and UPS 224 are shown. The motor 222 is operatively coupled to the control panel 232 such as an apparatus, or station, or location, which is operatively coupled to the mixing electronics 238 and the mixing computer 240. A power backup generator 236 provides power in the case of a power loss. Turbidity data and the STURM mesocosm status from the mixing computer 240 can be accessed on the remote computer 250.

Control module 230 includes a control panel 232, sensor (OBS-3) electrical panel 234, mixing electronics 238, UPS 242 and computer 240. Computer 240 is any suitable computer with sufficient processing power and memory capacity to operate the resuspension system. In non-air conditioned locations, a Toughbook laptop is recommended to withstand summer heat and water.

The remote computer 250 includes display and input/output devices 252. The computer 250 may be any suitable computing device and/or remote device having I/O capability. This includes handheld devices such as, for example, a tablet, an Internet enabled device, smart phone, iPhone or other suitable device or apparatus that is configured to receive data and display data and transmit data.

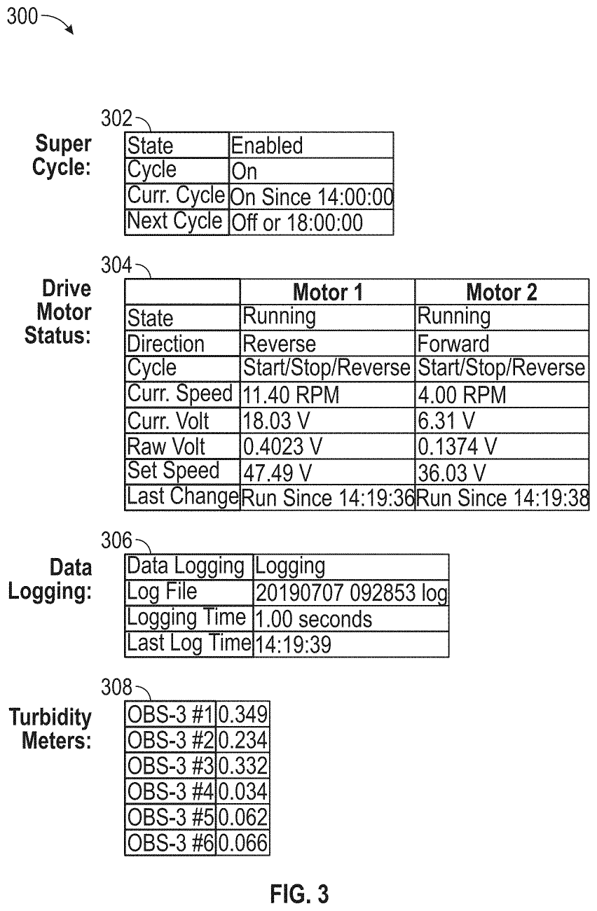

FIG. 3 shows an example of a status page 300 according to an embodiment of the disclosure. This status page 300 includes various outputs, such as super cycle 302, drive motor status 304, data logging 306 and turbidity meters 308. Each of these status indicators may be transmitted to a remote location, such as a server, as described herein, cell phone, tablet, or other suitable device that provides access to a user.

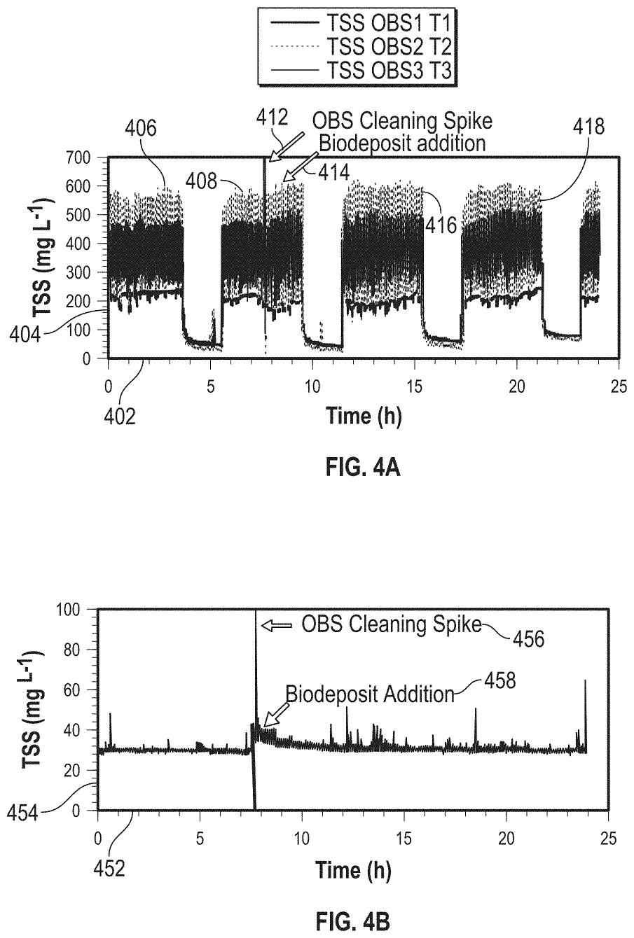

FIGS. 4A and 4B show a representation of a suspended solids concentration in a resuspension tank and non-resuspension tank, respectively.

FIG. 4A shows results of a resuspension tank over time, as described herein, in hours, plotted on the X-axis 402 and Total Suspended Solids (TSS) concentration (mgL⁻¹) on the Y-axis 404. Portions 406, 408, 416 and 418 are shown. Specifically, portion 412 shows an OBS cleaning spike and portion 414 shows a biodeposit addition.

FIG. 4B shows time, in hours, in a non-resuspension tank plotted on the X-axis 452 and TSS (mgL⁻¹) on the Y-axis 454. Portion 456 shows an OBS cleaning spike and portion 458 shows a biodeposit addition.

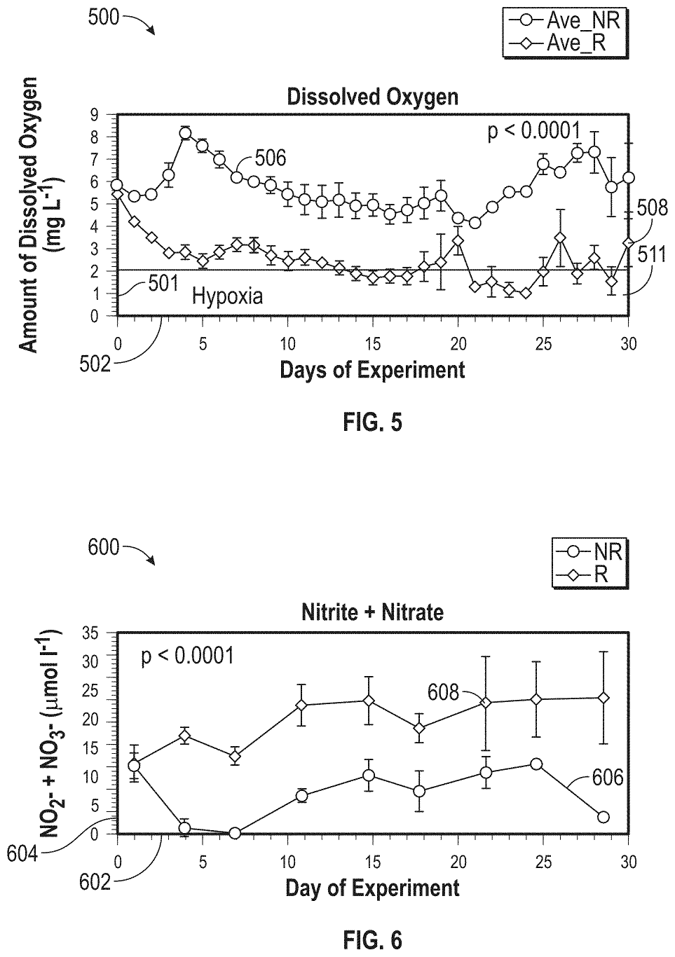

FIG. 5 shows an illustration 500 of dissolved oxygen concentrations in the resuspension tanks, as described herein, and non-resuspension tanks. All tanks received daily additions of oyster biodeposits N=3 for each system. Mean+/−one standard deviation. Values less than or equal to 2 mgL⁻¹ indicate hypoxia 511. Days of the experiment are plotted on the X-axis 502 and amount of dissolved oxygen (mgL⁻¹) on the Y-axis 501. Plot 506 shows a plot of average dissolved oxygen in a non-resuspension tank and plot 508 shows a plot of average dissolved oxygen in a resuspension tank, as described herein. Values shown are the average (mean)+/−one standard deviation.

FIG. 6 shows an illustration 600 of nitrite and nitrate concentrations in the resuspension tanks, as described herein, and non-resuspension tanks. All tanks received daily additions of oyster biodeposits N=3 for each system. Values shown are the average (mean)+/one standard deviation. Days of the experiment are plotted on the X-axis 602 and amount of nitrite plus nitrate (NO₂⁻ plus NO₃) in μmolL⁻¹ on the Y-axis 604. Plot 606 shows a plot of nitrite and nitrate concentrations in a non-resuspension tank and plot 608 shows a plot of nitrite and nitrate concentrations in a resuspension tank, as described herein.

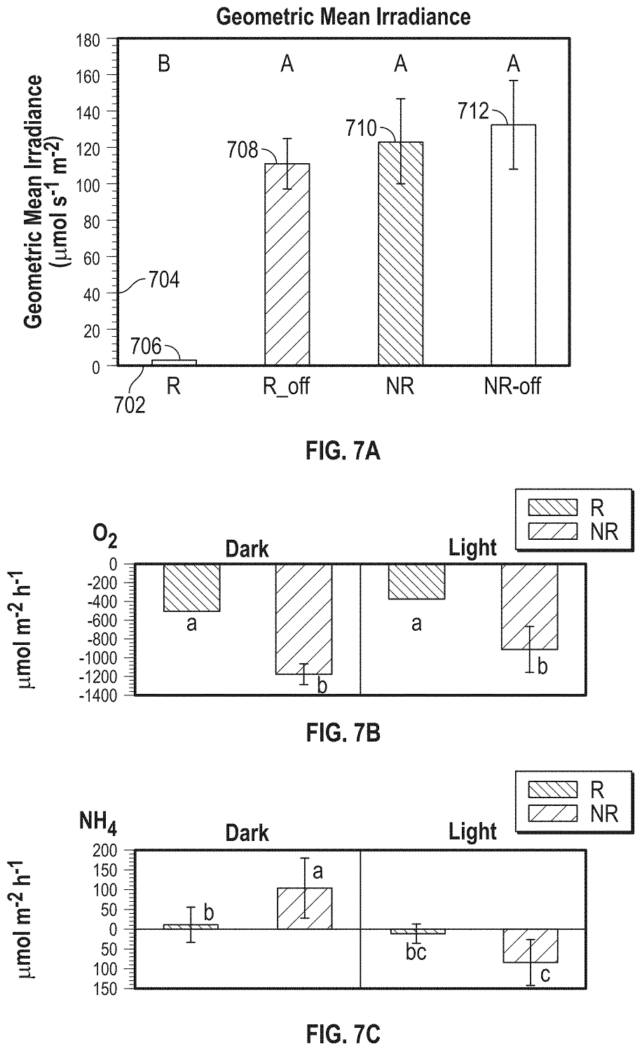

FIG. 7A shows an illustration of irradiance in the resuspension tanks and the non-resuspension tanks. All tanks received daily additions of oyster biodeposits N=3 for each system. Values are average (mean)+/−one standard deviation. An operating status of the resuspension and non-resuspension tanks are plotted on X-axis 702, geometric mean radiance (μmols⁻¹ m⁻² s⁻¹) is plotted on Y-axis 704. Mixing “on” of the resuspension tank is shown by bar 706. Mixing “off” of the resuspension tank is shown by bar 708. Mixing “on” of the non-resuspension tank is shown by bar 710. Mixing “off” of the non-resuspension tank is shown by bar 712.

FIG. 7B shows dissolved oxygen fluxes (μmolm⁻² h⁻¹) at the end of a 4-week experiment in the resuspension tanks R and non-resuspension tanks NR. All tanks received daily additions of oyster biodeposits N=3 for each system. Values shown are the average (mean)+/one standard deviation.

FIG. 7C shows ammonium fluxes (μmolm⁻² h⁻¹) at the end of a 4-week experiment in the resuspension tanks R and non-resuspension tanks NR. All tanks received daily additions of oyster biodeposits N=3 for each system. Values shown are the average (mean)+/−one standard deviation.

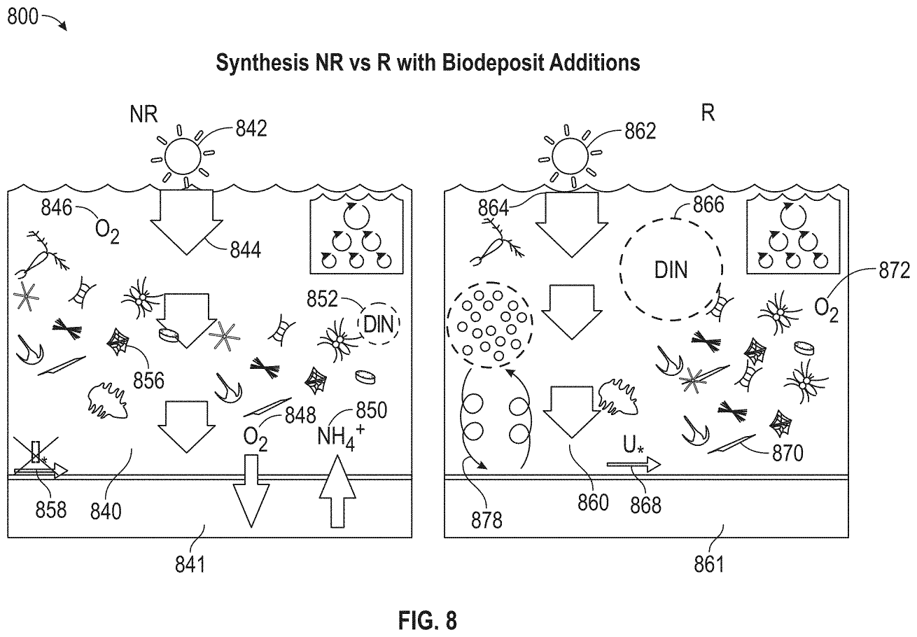

FIG. 8 shows an illustration 800 of synthesis with non-resuspension and with resuspension, as described herein, with biodeposit additions. In the non-resuspension tank, shown as the left-hand side (NR) sunlight 842 penetrates or propagates through water as 844. having oxygen 846 in the water 840. Oxygen 848 is absorbed in the sediment layer 841 and ammonium efflux is observed 850. NH₄⁺ 850 is released from the sediment layer 841. Dissolved Inorganic Nitrogen (DIN) 852 and organisms 856 are also shown. Bottom shear velocity (u_{*}) 858 is very low as shown by the strike-through of 858. The resuspension tank, shown as the right-hand side (R), shows light 862 penetrating water 860 as 864. Recirculating matter 878 is shown in water 860 and interacting with sediment layer 861. Dissolved Inorganic Nitrogen (DIN) 866 and oxygen 872 are also shown. High bottom shear velocity (u_{*}) 868 is present in the resuspension tank. Oxygen 872 is taken up by resuspended particulates 878. Organisms 870 are also shown. It is also considered that infaunal organisms may be included in this system.

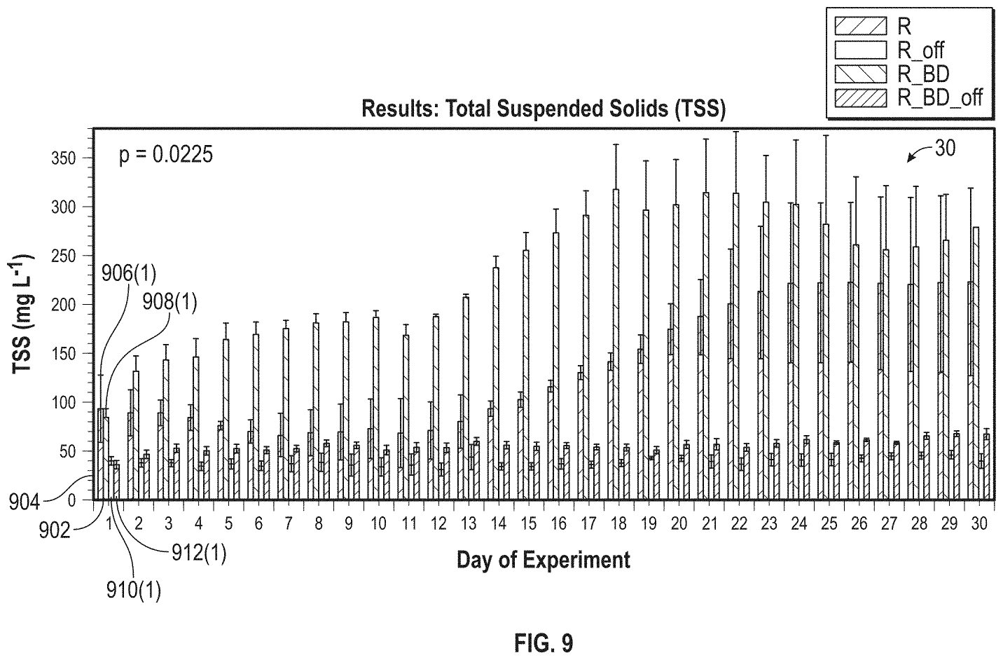

FIG. 9 shows a graphic illustration 900 of results of total suspended solids (TSS) in resuspension tanks (R) and resuspension tanks with daily additions of oyster biodeposits (R_BD) with mixing “on” and mixing “off”. Days of the experiment are plotted on the X-axis 902 and total suspended solids (TSS) concentrations (mgL⁻¹) on the Y-axis 904. Each day shows 4 vertical lines. Lines 906(1) . . . (n) (where “n” is any suitable number, for a thirty-day experiment, it could be one per day, so 30 is a suitable number) show the levels for the resuspension tank with mixing on and no oyster biodeposits. Lines 908(1) . . . (n) show the levels for the resuspension tank with mixing on and daily additions of oyster biodeposits. Lines 910(1) . . . (n) show the levels for the resuspension tank with mixing off and no daily additions of oyster biodeposits. Lines 912(1) . . . (n) show the levels for the resuspension tank with mixing off and daily oyster biodeposits. Levels shown are the average (mean)+/−one standard deviation.

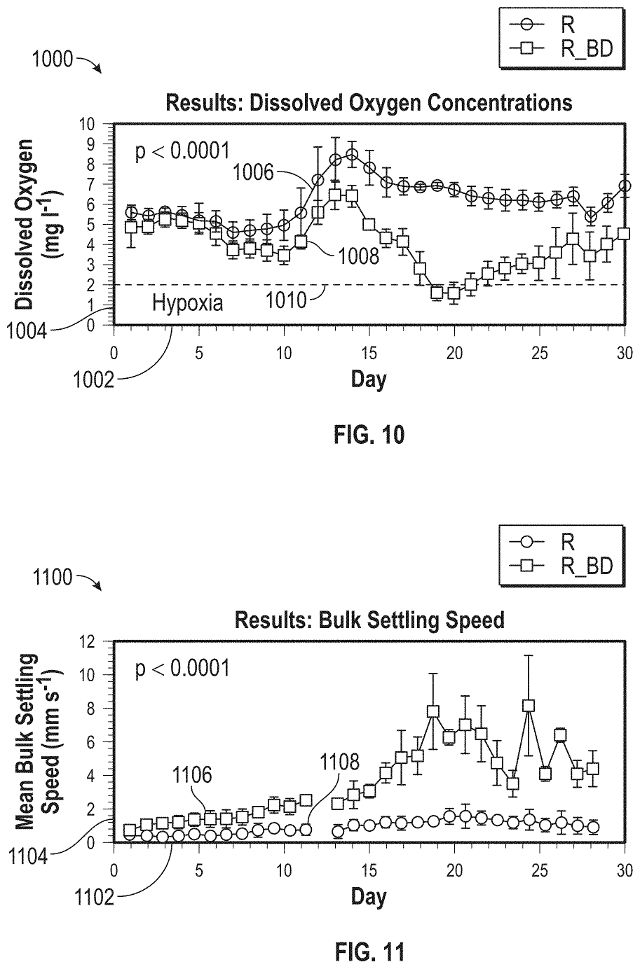

FIG. 10 shows a graphic illustration 1000 of results of dissolved oxygen concentrations. Days 1-30 are plotted on the X-axis 1002. Dissolved oxygen (mgL⁻¹) is plotted on the Y-axis 1004. Plot 1006 shows the levels in the resuspension tanks without a daily addition of oyster biodeposits. Plot 1008 shows dissolved oxygen concentrations in the resuspension tanks with daily additions of oyster biodeposits. N=3 for each system. Values shown are the average (mean)+/−one standard deviation. Values less than or equal to 2 mgL⁻¹ indicate hypoxia 1010.

FIG. 11 shows a graphic illustration 1100 of results of mean bulk settling speed. Days 1-30 are plotted on the X-axis 1102. Mean bulk settling speed (mm s⁻¹) is plotted on the Y-axis 1104. Plot 1106 shows the levels in the resuspension tanks with a daily addition of oyster biodeposits. Plot 1108 shows the levels in the resuspension tanks without daily additions of oyster biodeposits. N=3 for each system. Values shown are the average (mean)+/−one standard deviation.

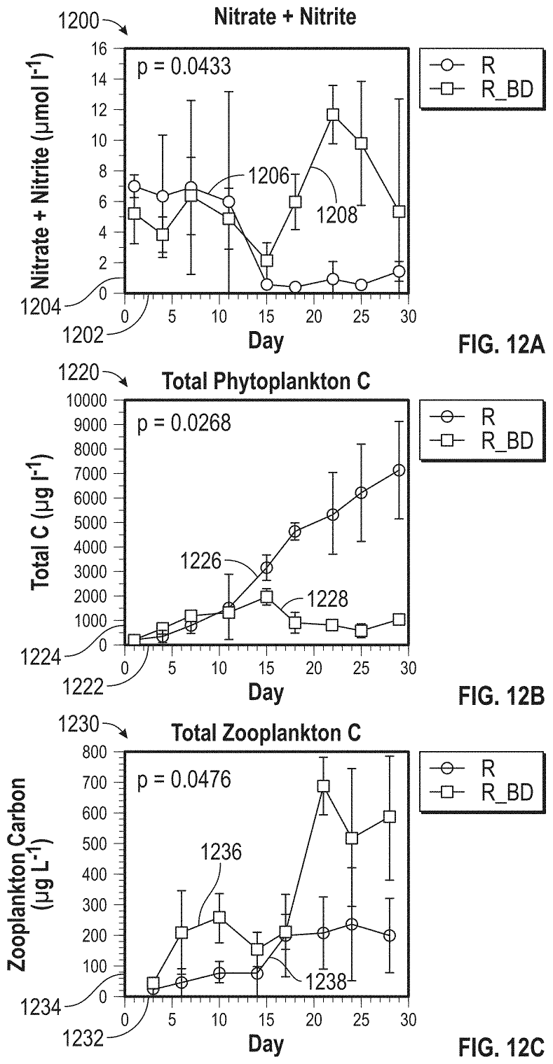

FIGS. 12A, 12B and 12C show graphic illustrations of nitrate plus nitrite and total phytoplankton carbon, and total zooplankton carbon, respectively.

FIG. 12A shows a representation 1200 of nitrite and nitrate concentrations in the resuspension tanks, as described herein. Days 1-30 are plotted on the X-axis 1202. Nitrite and nitrate concentration (μmolL¹) is plotted on the Y-axis 1204. Plot line 1206 shows the levels in the resuspension tanks without daily additions of oyster biodeposits. Plot line 1208 shows the levels in the resuspension tanks with daily additions of oyster biodeposits. N=3 for each system, values shown are mean+/−one standard deviation.

FIG. 12B shows a representation 1220 of total phytoplankton carbon (μgL⁻¹) concentrations in the resuspension tanks, as described herein. Days 1-30 are plotted on the X-axis 1222. Total phytoplankton carbon (μgL⁻¹) is plotted on the Y-axis 1224. Plot 1226 shows the levels in the resuspension tanks without daily additions of oyster biodeposits. Plot 1228 shows the levels in the resuspension tanks with daily additions of oyster biodeposits. N=3 for each system, values are mean+/−one standard deviation.

FIG. 12C shows a representation 1230 of total zooplankton carbon (μgL⁻¹) concentrations in the resuspension tanks, as described herein. Days 1-30 are plotted on the X-axis 1232. Total zooplankton carbon (μgL⁻¹) is plotted on the Y-axis 1234. Plot 1236 shows the levels in the resuspension tanks with daily additions of oyster biodeposits. Plot line 1238 shows the levels in the resuspension tanks without daily additions of oyster biodeposits. N=3 for each system, values are mean+/−one standard deviation.

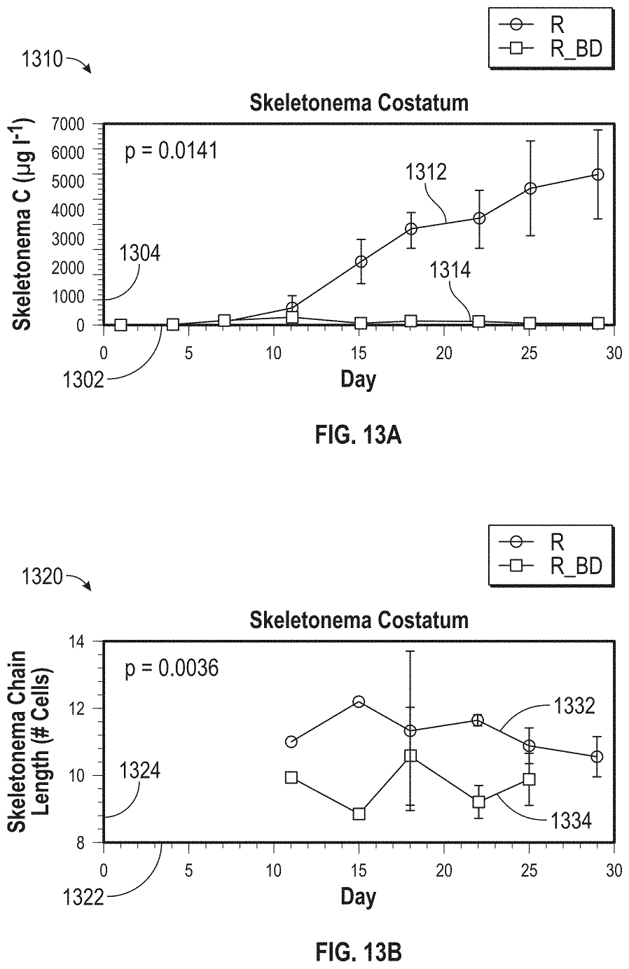

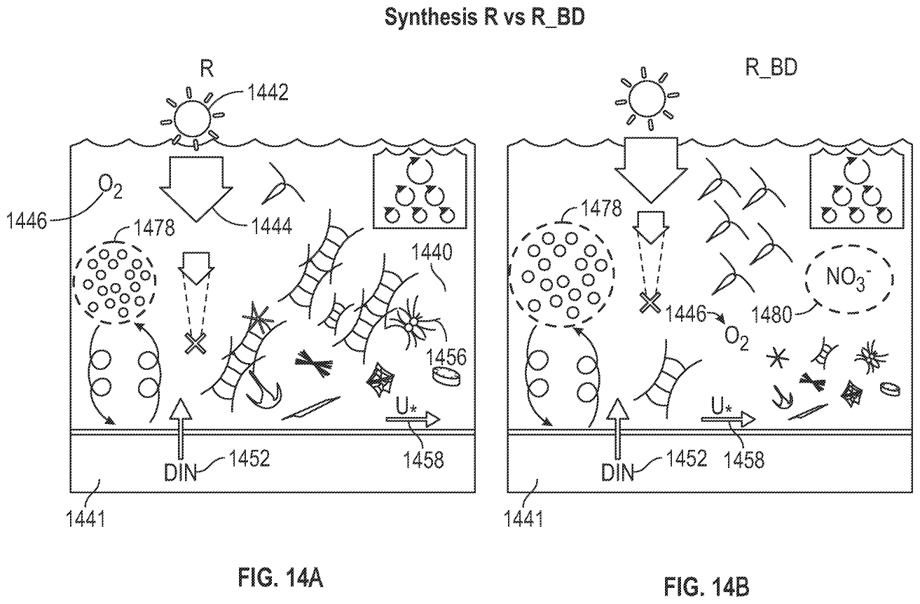

FIGS. 13A and 13B show graphic representations of Skeletonema costatum biomass and chain length, respectively.

FIG. 13A shows a representation 1310 of Skeletonema costatum biomass (μgL⁻¹) concentrations in the resuspension tanks, as described herein. Days 1-30 are plotted on the X-axis 1302. Total Skeletonema costatum biomass (μgL⁻¹) is plotted on the Y-axis 1304. Plot 1312 shows the levels in the resuspension tanks without daily additions of oyster biodeposits. Plot 1314 shows the levels in the resuspension tanks with daily additions of oyster biodeposits. N=3 for each system, values shown are the average (mean)+/−one standard deviation.

FIG. 13B shows representation 1320 of Skeletonema chain length in the resuspension tanks, as described herein. Days 1-30 are plotted on the X-axis 1322. Skeletonema chain length (number of cells) is plotted on the Y-axis 1324. Plot line 1332 shows the levels in the resuspension tanks without daily additions of oyster biodeposits. Plot line 1334 shows the levels in the resuspension tanks with daily additions of oyster biodeposits. N=3 for each system, values shown are the average (mean)+/−one standard deviation.

FIGS. 14A and 14B show an illustration of synthesis using resuspension with and without bio-deposits. FIG. 14A shows resuspension without biodeposits and FIG. 14B shows resuspension with biodeposit additions.

In the non-biodeposit portion (FIG. 14A), sunlight 1442 penetrates or propagates through water 1440 as 1444 having oxygen 1446 in the water 1440. The sediment layer 1441, DIN 1452 and organisms 1456 are also shown. In the resuspension tank with biodeposit additions (FIG. 14B), dissolved oxygen concentrations 1446 are decreased due to enhanced total suspended solids 1478. High bottom shear velocity u_{*} 1458 is present in the resuspension system and the resuspension system with daily oyster biodeposit additions. Total suspended solids 1478 are shown in water 1440 and interacting with sediment layer 1441 through resuspension and deposition during mixing “on” and mixing “off” phases.

The resuspension tank with biodeposits is very similar and includes high quantities of regenerated NO₃⁻ 1480. The differences in organisms (Skeletonema costatum, zooplankton) and oxygen levels are very different as shown qualitatively. It is also considered that infaunal organisms may be included in the systems shown in FIGS. 14A and 14B.

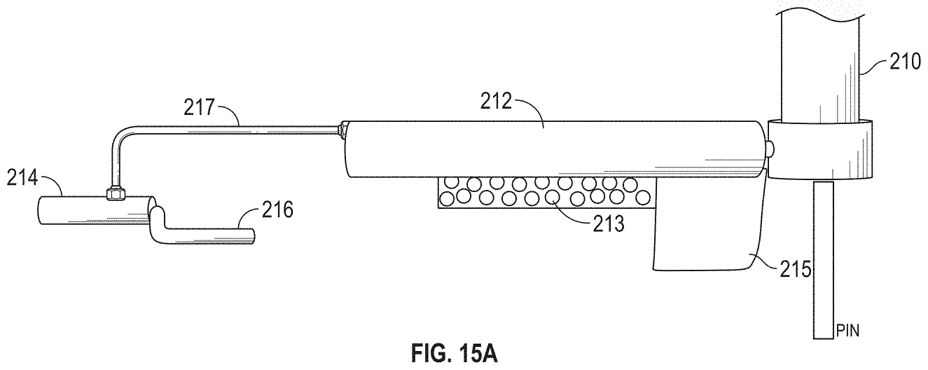

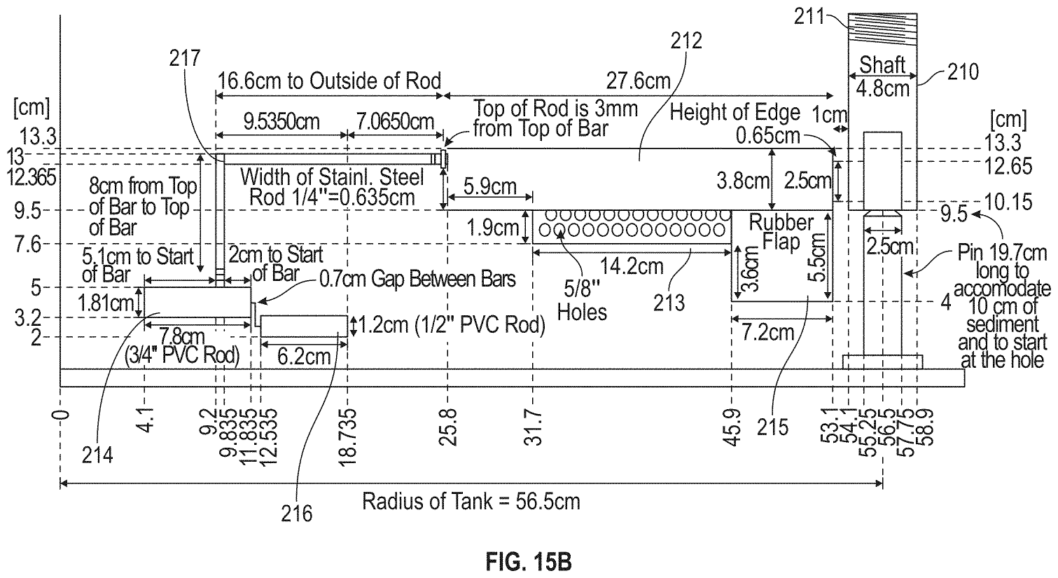

FIGS. 15A and 15B illustrate examples of a resuspension mechanism 209 according to some of the embodiments disclosed herein. FIG. 15A shows a perspective view including shaft 210. Horizontal member 212, flexible flap 215, perforated portion 213, arm portion 217, first horizontal member 214 and second horizontal member 216.

FIG. 15B shows an engineering schematic with dimensions shown (drawing not to scale). As shown in FIG. 15B, the threaded portion 211 is on an interior surface of the shaft 210. This threaded portion 211 includes one or more threaded grooves that permit a height adjustment of the shaft, and thus the members 212, 213, 215, 217, 214 and 216 relative to the bottom of the tank and/or sediment layer, as described herein. The threaded portion 211 may be used to adjust the height of the resuspension mechanism 209 before the start of an ecosystem experiment. Paddle height can also be checked during an “off” period of the cycle during an ecosystem experiment aided by underwater video with light.

Paddle setup in exact distance to the bottom is important. To more easily install and remove a paddle from a STURM tank, the paddle shaft contains a coupling. On the coupling, the coupling side with the O-ring is located at the bottom so the O-ring does not fall off when moving the paddle. So that the shaft does not play loose during the experiment, two nuts and a washer are used for tightening the paddle shaft to the right-angle gear drive.

To help to easily adjust the paddle height above the bottom, the connection of the paddle shaft with the right-angle gear drive was fitted and threads inside the paddle shaft made to fit the threads of the right angle gear drive. At setup, the paddle shaft was threaded up as far as needed for the paddle to be in the correct position above the sediment.

The design of a Shear TUrbulence Resuspension Mesocosm (STURM) system produces high bottom shear stress uniformly distributed over the bottom, produces realistic sediment resuspension, and produces realistic water column RMS turbulent velocity and energy dissipation rates over a wide range of mixing settings. STURM is a calibrated, replicated system that provides the ability to program, or “dial-in”, the desired combination of bottom shear and turbulence to achieve fully reproducible conditions for experiments in multiple replicate tanks. The system, as described herein, functions reliably over sustained time periods (e.g., 4 weeks) to allow for extended whole ecosystem benthic-pelagic coupling studies.

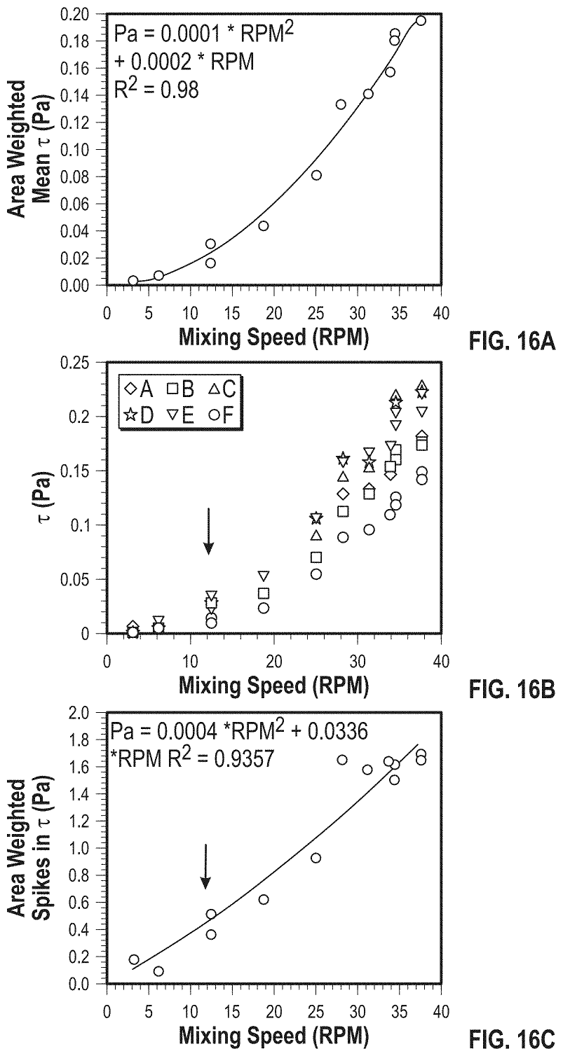

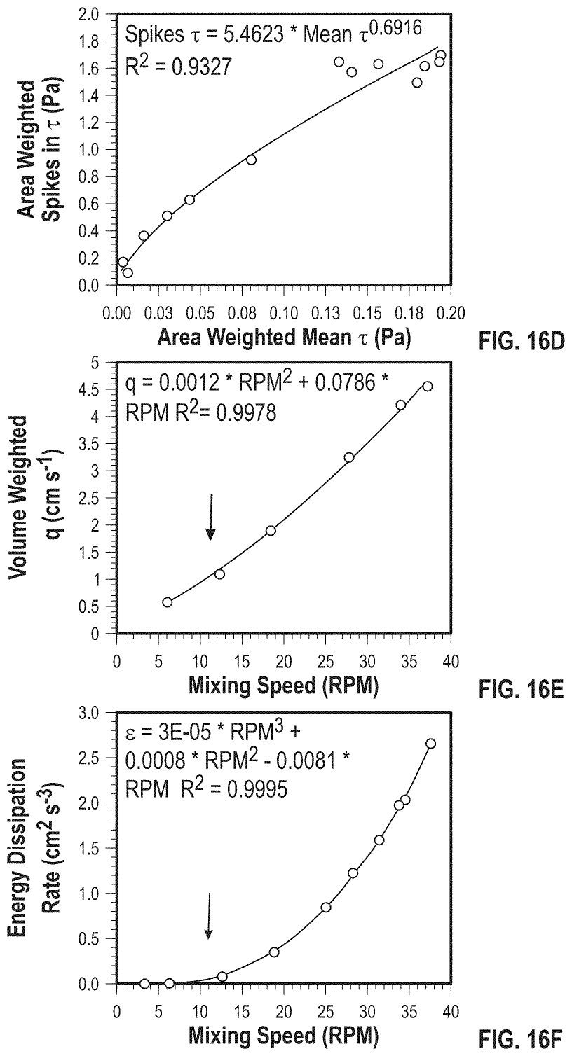

FIGS. 16A-F show graphical representations of water column turbulence levels and bottom shear stress over a range of mixing settings in STURM tank.

Water column turbulence levels and bottom shear stress over a range of mixing settings in the STURM tank. FIGS. 16A-F show (A) Average, area-weighted mean shear stress over mixing speed; (B) shear stress at each sensor location over mixing speed; (C) area weighted spikes in stress over mixing speed (all sensors); (D) relationship of area-weighted spikes in the shear stress over area weighted average stress (all sensors); (E) volume-weighted RMS turbulent velocity over mixing speed; (F) volume-weighted energy dissipation rate over mixing speeds. For mixing speed at pre-determined paddle rotations per minute (RPM), the paddle goes forward, stops, goes backward and stops, and repeats the forward, stop, backward, stop pattern, as programmed. For example, in one embodiment, the paddle goes forward for approximately 8 seconds, stops for approximately 1.5 seconds, goes backward for approximately 9 seconds and stops for approximately 1.5 seconds, and then repeats for the duration of the “on” period. This pattern may be programmed to be different. Alternatively, the paddle goes forward for approximately 9 seconds, stops for approximately 1.5 seconds, goes backward for approximately 8 seconds and stops for approximately 1.5 seconds, then repeats for the duration of the “on” period. Alternatively, the paddle may move backwards, stop, move forward, stop, repeat. The time intervals may be as described or longer or shorter.

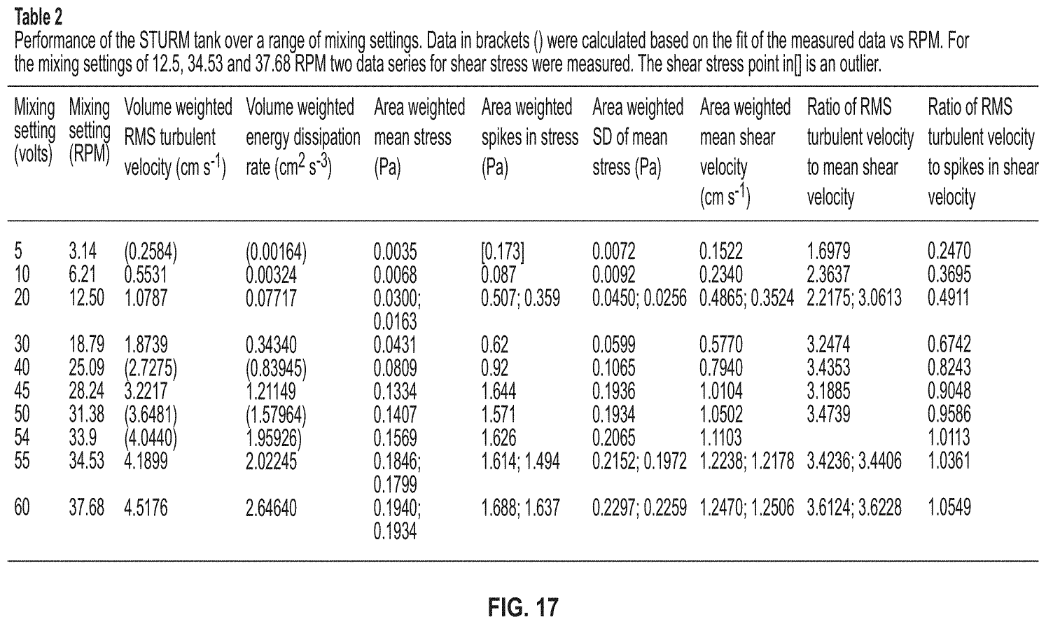

FIG. 17 shows a representation of performance of the STURM tank over a range of mixing settings.

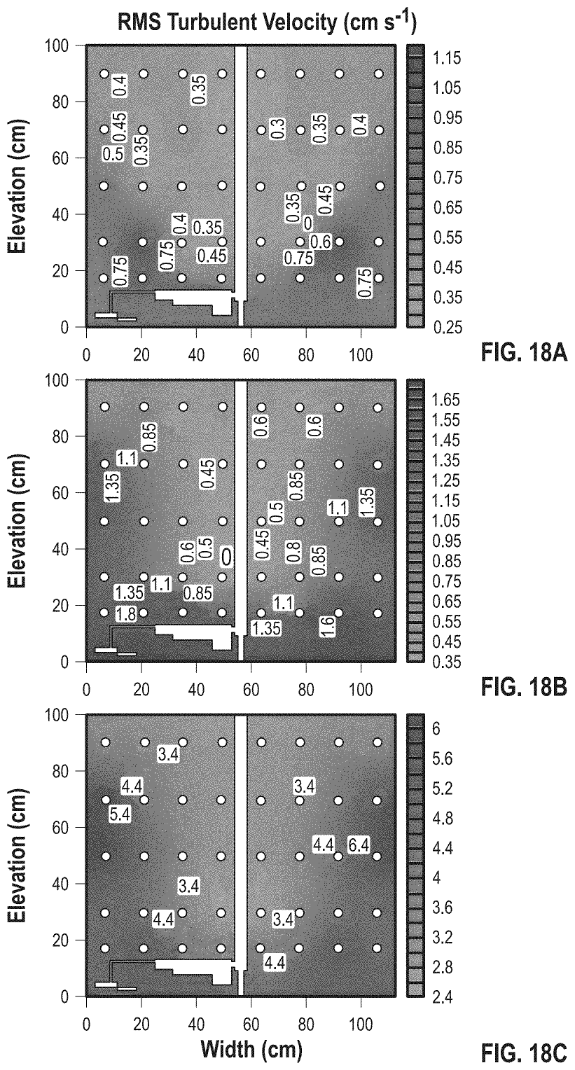

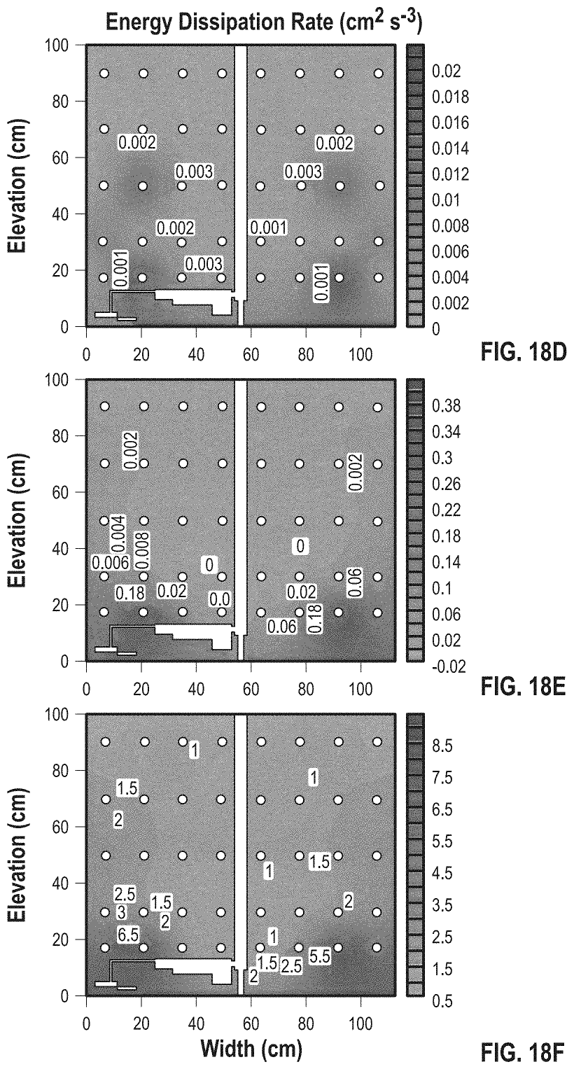

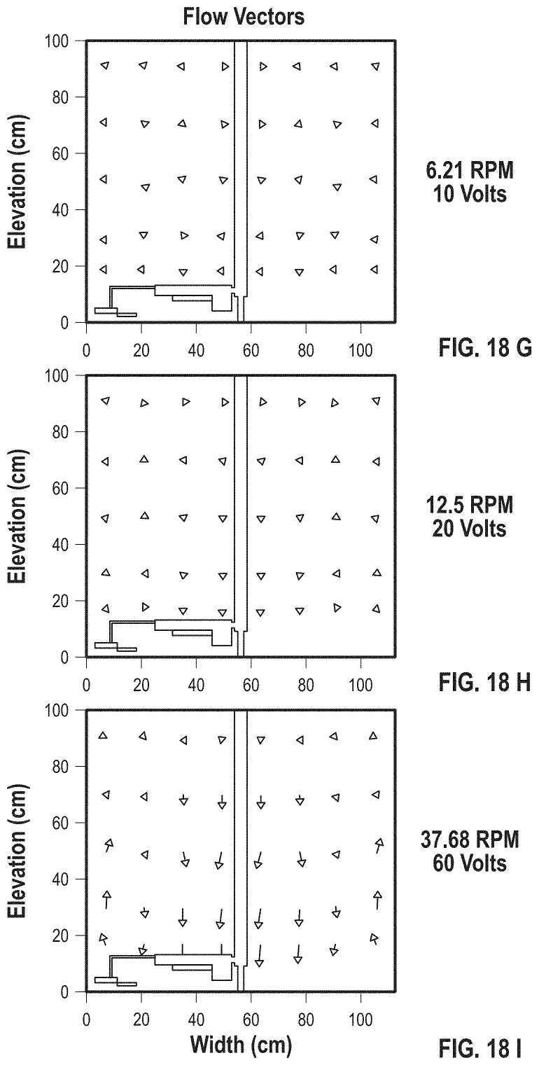

FIGS. 18 A-I show water column RMS turbulent velocity, energy dissipation and flow vectors at various mixing settings. Water column RMS turbulent velocity (A, B, C), energy dissipation rate (D, E, F), and flow vectors in a STURM tank (G, H, I) at mixing settings of 6.21, 12.5, and 37.68 RPM are shown. As described above, for mixing, the paddle goes forward, stops, goes backward, and stops.

Provided herein is a description of the STURM tank design, illustrating how the fluid dynamics variables of the STURM tank at different mixing speeds were assessed and how the tanks performed over a wide range of mixing settings. In addition, examples are provided showing how the STURM tanks were used to address interdisciplinary ecological, physical, and chemical benthic-pelagic coupling questions and the general procedures followed during these ecosystem experiments.

The below description uses reference numerals from FIG. 2 as a frame of reference to facilitate the description.

The STURM tank system included six 1000-L STURM tanks (generally similar to tank 101). Each tank (101) is approximately 113 cm in outer diameter and approximately 132 cm tall, made with approximately 0.18 cm thick walls of white fiberglass (Solar Components Corporation, Manchester, N.H., USA). Operationally, this gives an approximately 1000-L tank volume with an approximately 1 m² sediment surface area and an approximately 1 m water column height (102). Mesocosms smaller than this can significantly affect ecosystem processes, while the approximately square aspect ratio (water column height 1 m, tank diameter 1.13 m) also does not limit light. This size and shape may be considered a lower size range for realistic inclusion of organisms up to the size of small fish although it has been contemplated that for long-term experiments with fish, approximately 2 to 4 m diameter systems may be preferred.

As described herein, the superstructure of the resuspension system included approximately 5 cm diameter aluminum tubes that minimized shading. Each superstructure held one motor (222) with a gear box and a drive train (230) for three STURM tanks. (one tank 101 shown in FIG. 2). To minimize heating of the tank water in the summer (temperatures as high as approximately 38° C. were recorded on the mesocosm pad), the tanks were insulated with Reflectix bubble wrap (Shelter Institute, Woolwich, Me., USA) and several layers of window screen shading were suspended over each superstructure during ecosystem experiments. Care was taken not to limit light to the experiment and light levels (photosynthetically active radiation) in four quadrants right under the water surface of all tanks was measured at the beginning of an ecosystem experiment and light profiles were measured throughout. Alternatively, the STURM facility can be set up indoors using light banks above the tanks or in a temperature-controlled greenhouse.

It is useful for a system that functions over a long period of time to have reliable controls, a repeatable physical environment, and the high physical realism for ecosystem experiments. A personal computer (240), equipped with a National Instruments data acquisition system and housed near the mesocosm facility, was dedicated to controlling the mixing systems and logging turbidity data. A second computer logged temperature. The mixing computer was connected to an enclosure with the mixing electronics (238) and signal conditioning electronics. The mixing drive on the seawater pad included a ½ HP enclosed 90 V DC motor (222), a worm gear reducer with a gear ratio of 30:1, and a tachometer/Generator (Kaman Industrial Technologies Corp, Dover, Del.). Right angle gear drives (Kaman Industrial Technologies Corp, Dover, Del.) were placed above each tank. Connected to the motor but housed indoors was a motor control panel (232) which included a DC motor controller (Kaman Industrial Technologies Corp, Dover, Del., USA), relay logic, and signal conditioning for computer speed control. Time variation in mixing was programmed either as alternating mixing ‘on’ and ‘off’ phases or as smoothly varying mixing intensity.

A backup generator (226) and UPS power backup (224) provided uninterruptible power to the mixing computer (240), the mixing electronics box (238), and the motors (232), in case of power outages. The system software automatically generated a status webpage for the STURM tanks including real time turbidity data collected with optical backscatter sensor turbidity sensors (236) (OBS-3, D&A Instrument Company, Port Townsend, Wash., USA). This was used for real time remote monitoring of the experiment status.

One significant feature of the STURM tank design was a single paddle (209) that produced both realistic water column mixing and realistic bottom shear stress in a single system. To avoid plug flow, the paddle (209) was programmed to move forward for approximately 9 s, stop for approximately 1.5 s, to move backward for approximately 8 s and stop 1.5 s. The following sections refer to paddle speeds when the paddles are moving, but the forward-pause-backward-pause cycle is implied. The paddle (209), which sweeps closely to the sediment surface, was connected to its drive shaft (210) at the top of the super-structure using a threaded rod to adjust paddle height in the tank, and was guided on a central vertical pin made of PVC that was attached to the center of the tank bottom. Each paddle was constructed of approximately 3.8 cm diameter PVC bar that approximately spanned the inner half of the tank (101) radius with a perforated plate (213) and an approximately 1.36 mm thick silicone flap (215) designed to locally enhance bottom shear. The end of the bar (212) has an approximately 6.35 mm diameter aluminum rod (217) that holds two approximately 1.81 cm diameter (214) and one approximately 1.2 cm diameter PVC rods (216) close to the sediment surface that locally enhanced bottom shear.

The paddle performance evaluation criteria included shear stress uniformity across the tank bottom and realistic ratios of water column turbulence to bottom shear velocity, measured as described below. For paddle design, water column turbulence measurements were collected at a single location at about 20 cm above the bottom and approximately in the middle of the tank radius, a location identified as having higher than average water column turbulence levels. After the paddle design was found, additional water column turbulence measurements were done at each mixing speed (4 across radius, 5 across water column height, total of 20 measurement spots to get volume weighted water column turbulence measurements). The combination of shear stress measurements, paddle modifications, and water column turbulence measurements at selected locations permitted determination of the STURM tank paddle design. As disclosed herein, the STURM paddle was designed specifically for the size and shape of the STURM tanks as described herein. The STURM paddle could also be adapted for other cylindrical tank sizes and shapes.

The system described herein utilized a filtration system that allowed rapid filtration of large quantities of water for a daily approximately 10% water exchange during ecosystem experiments.

Benthic shear stress is one important variable for flow at the sediment-water interface since it affects sediment resuspension. An important design criterion was therefore that bottom shear had to be substantially uniform across the sediment surface to allow evenly distributed erosion in the STURM tank. In addition, the bottom shear had to be sufficiently high to induce sediment resuspension, without over-stirring the tank. Hot film anemometry was used to determine the bottom shear stresses at different locations across the radius over a range of mixing speeds, independent of sediments. Bottom shear stress τ_{b}, the relevant variable for resuspension, is a function of shear velocity u_{*} and can be expressed as the inverse of equation 1

τ_{b}=ρu_{*}²

Type WT G-50A sensors from Micro Measurements (Raleigh, N.C., USA) were used that included constant temperature anemometry cards (TSI PN 2605462 Rev. B) with a selected overheat ratio of approximately 1.05 at approximately 23.4° C. for the shear stress measurements. Data were recorded for greater than 5 minutes as voltage output on a Tattletale Model No. 5F datalogger at a sampling rate of 20 Hz. The 7th channel of the Tattletale datalogger was used to log and monitor the temperature near the shear stress sensors, using a small YSI 44006 precision thermistor (YSI Inc., Yellow Springs, Ohio, USA). All measurements were done with flush-mounted shear stress sensors in a false-bottom plate.

The shear stress sensors were designed according to the parameters of the system. However, durable, thin, waterproof sensor cables were used. The thicker sensor cables, typically used for similar experiments, were replaced with 32-gauge Teflon coated cable (part no 02f9447 Newark Electronics, Chicago, Ill., USA) and twisted together to form an approximately 1 mm thick bundle to each sensor. The cables were run underneath a false-bottom plate in the STURM tank and underneath the bottom of a microcosm calibration device so that the cables would not produce flow interference above the sensor plates.

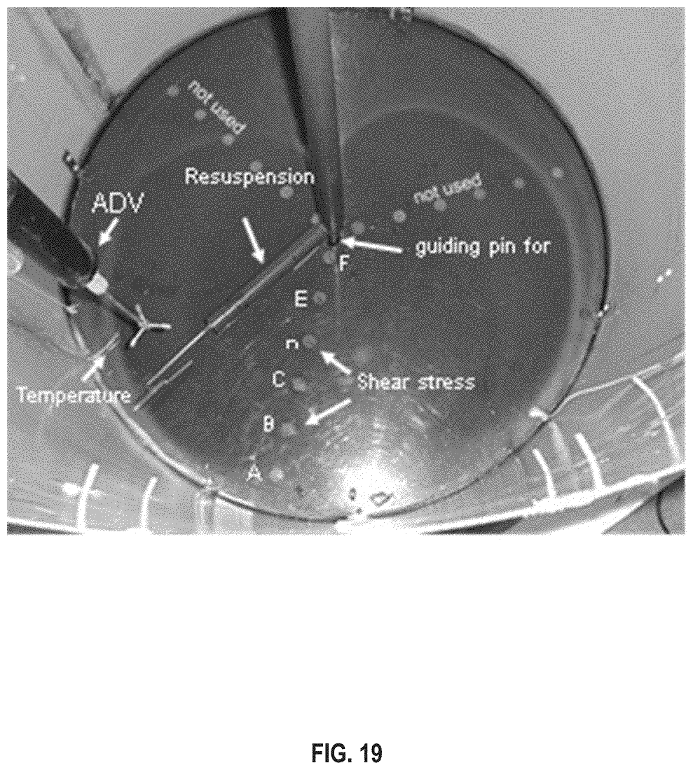

FIG. 19 depicts a view into a STURM tank, in accordance with an embodiment of the present disclosure. The STURM tank has the false-bottom in place, flush mounted shear stress sensors, a temperature sensor, and an Acoustic Doppler Velocimeter (ADV). Reference characters A-F are the locations of the shear stress sensors.

The shear stress sensors were calibrated over a range of shear velocities from approximately 0 to approximately 2.1 cm s⁻ in an approximately 40 cm Gust microcosm. With this range in shear velocities, the wide range of bottom shear velocities in the STURM tank were covered. Sensor calibration voltage data were converted to bottom shear velocities. The calibrations were then applied to the time series data from the tank to calculate the shear velocity and the shear stress time series. All sensor calibrations and bottom shear measurements were run in freshwater at a temperature of approximately 23.4° C.

After completion of the paddle design process, shear stresses were measured at ten mixing speeds and at six different radial positions to fully characterize the operational performance of the system. During set-up and calibration, shear stress sensors were placed radially at approximately 4.5 cm, approximately 13.5 cm, approximately 22.5 cm, approximately 31.5 cm, approximately 40.5 cm, and approximately 49.5 from the tank center. Each sensor was used to represent the approximate area of its associated enclosing sector of tank bottom for area-weighted shear stress averaging.

After each run, area-weighted histogram analyses and descriptive statistics were calculated for each sensor at each mixing speed. The average shear stress for each sensor was determined from the time series data, the data were weighted for their respective areal portions, and the overall areal-weighted shear stress in the STURM tank at each mixing setting was determined by summing the weighted contributions of all sensors.

Resuspension is related most clearly to spikes in shear stress, rather than the average shear stress. Large spikes in stress were associated with the passage of the paddle directly over the sensors. To quantify these spikes in stress, a calculation was made of the expected paddle passages for each experimental setting as approximately 17 s/20 s (the fraction of time the paddle was in motion) times the rate of rotation (in rotations s⁻¹) times the duration of each time series of stress measurements in s (T), which yields N=0.0142·RPM·T spikes expected. A characteristic spike stress was estimated simply as the average of the highest N observed stresses in each time series. Note that N is an increasing fraction of the total number of data points as RPM increases.

Water column RMS turbulent velocity and energy dissipation rate are two relevant water column mixing variables to be mimicked realistically in the mesocosm in addition to generating appropriate bottom shear stress. Mean flow and turbulence were measured with a 10 MHz Acoustic Doppler Velocimeter (ADV, Sontek/YSI Inc. San Diego, Calif., USA), at 20 locations over half a tank for six mixing settings from approximately 6.2-37.7 RPM to characterize spatial variability at different mixing speeds. All measurements were performed in substantially clear water, seeded with neutrally buoyant Sontek particles. Time series of all 3 orthogonal components of velocity were collected for approximately 10-minute periods, sampled at approximately 25 Hz, at each measurement location.

The calculated mean flow speed at each location is:

U_{mean,tot}=\sqrt{U²_{+V}_{²}_{+W}_{²}}

where U, V, W are the mean flow velocity components in the x (toward the wall), y (circumferential) and z (vertical) directions, respectively, over the measurement interval. We determined water column RMS turbulent velocity (q).

$$q = \sqrt{\frac{1}{3} ( 〈 {u}^{2} 〉 + 〈 {v}^{2} 〉 + 〈 {w}^{2}} 〉 )$$

where <u²>, <v²>, and <w²> are the variances of their respective velocity components. Energy dissipation rates were determined as

$$ɛ = \frac{2 π}{[ {U}_{m e a n , t o t} ] or [ q ]} {1.9 [ \frac{E ( f ) {f}^{\frac{5}{3}}}{2} ]}^{\frac{3}{2}}$$

where E(f) is the measured turbulence spectrum over the inertial subrange.

The ratio of mean flow speed and RMS turbulent velocity determined whether U_{mean,tot} or q was used in Equation 6 to implement the frozen turbulence conversion between temporal and spatial frames of reference. For mean flow speeds larger than the RMS turbulent velocity, U_{mean,tot} was used, and for RMS turbulent velocity larger than the mean flow speed, q was used.

Using a Kriging technique in Surfer (Golden Software, Golden, Colo., USA), an estimate was made of the volume-weighted RMS turbulent velocity and energy dissipation rate at different mixing speeds at four locations across the tank radius, five heights across the tank height, as shown generally in the circles in FIG. 18 (20 evenly spaced locations over tank radius and height). The volume-weighted RMS turbulent velocity and energy dissipation rates were non-linearly related to mixing speed and a 2nd degree polynomial curve fit (R²=0.9978) to RMS turbulent velocity and a 3rd degree polynomial curve fit to energy dissipation rate (R²=0.9995) in order to interpolate between measured mixing speeds.

Procedures for 4-week ecosystem experiments in the STURM tanks were developed. Substantially muddy homogenized approximately 10 cm deep sediments without macrofauna were equilibrated for 13 d with about 20 cm oxygenated overlying water to allow realistic porewater gradients to develop before the start of the ecosystem experiment. Any infauna (e.g. hard clams) were added and allowed to bury at the end of the sediment equilibration phase and three days before an ecosystem experiment was started. Unfiltered estuarine water was added incrementally to avoid resuspending sediments in all tanks, after which mixing was initiated. Tidal resuspension was mimicked by setting the desired bottom shear stress and running the experiments at approximately 4 hours “on” and approximately 2 hours “off” to simulate tidal resuspension for 4-week experiment, but any tidal cycling can be programmed, or dialed in.

Optical backscatter (OBS) turbidity measurements were taken continuously in all tanks and were calibrated by directly measuring samples of total suspended solid (TSS). Temperature was measured continuously using Campbell temperature probes. In the experiments, water column parameters were sampled during the morning mixing on-phase every two days, zooplankton biweekly, and approximately 1 cm diameter sediment cores were taken from the tanks at the beginning, in the middle and at the end of the 4-week experiment. While this sampling strategy was sufficient, other sampling regimes are also contemplated.

Laser in-situ Scattering and Transmissometry (LISST 100×, Sequoia Scientific, Bellevue, Wash.) particle size distribution measurements were made as needed (e.g., settling periods). If sediment bio geo-chemical flux measurements and stepwise sediment core erosion experiments are desired, such experiments can be run on equilibrated sediment cores set up under similar conditions as the tanks at the start and/or, by sampling destructively, at the end of the ecosystem experiment. Also, stepwise erosion experiments can be conducted in the STURM tanks. Storms can be simulated in the STURM systems. The erosion and storm conditions can be produced in the STURM tanks by adjusting movement of the resuspension mechanism, such as a paddle, as described herein, as well as adjusting other features of the STURM tanks. The conditions may be replicated in the tanks using programmed parameters of the computer(s) as described herein.

In the conducted experiments, approximately 10% of the tank water was exchanged daily at the end of the mid-day mixing “off” phase with approximately 0.5 μm absolute filtered water to mimic external tidal exchange and to replace sampled water. Other exchange rates can be used. For the water exchanges, approximately 20 μm filtered water from a seawater facility was passed through between approximately 1 μm and 0.5 μm absolute filtration systems, which was integral to the STURM facility so that the added water contained no particulates. This exchange water was characterized for mass balance purposes.

Light and other water quality measurements were also performed during the afternoon. For system maintenance, the interior walls of three tanks were cleaned daily during the mid-day mixing off phase to prevent wall growth artifacts, such that all tank walls were cleaned every other day or more often.

The fluid-dynamical performance of the STURM tanks with results on bottom shear stress, RMS turbulent velocity, and energy dissipation rate as a function of mixing speed as well as the ratio of RMS turbulent velocity to shear velocity was evaluated. Examples of benthic-pelagic coupling experiments were performed using only a few mixing settings but yielded unexpected, non-linear and indirect results that would not have been observed with conventional approaches.

Also described are the realistic bottom shear stress and water column turbulence in the STURM systems for realistic benthic-pelagic coupling experiments. Previous devices did not measure RMS turbulent velocity, energy dissipation rate and bottom shear stress in a single system, which leads to disadvantages and artifacts if benthic-pelagic coupling studies are desired.

Average area-weighted shear stress increased quadratically with mixing speed (FIG. 16A). Shear stress was approximately homogeneous across the bottom of the STURM tank at all locations and at all mixing speeds (FIGS. 16A-F) except for a location near the tank center which represents only 2.5% of the total surface area. Large spikes in the shear stress data were observed, with magnitudes much greater than the corresponding mean stress. For example, though the area weighted bottom shear stress at 12.5 RPM was low, between approximately 0.0300 and approximately 0.0163 Pa, the shear stress spikes reached between approximately 0.359 and approximately 0.507 Pa (FIG. 17). The magnitude and frequency of the spikes increased with mixing speed (FIG. 16A). The spikes in the shear were approximately 0.09 Pa at approximately 6.2 RPM and approximately 1.7 Pa at approximately 37.7 RPM (FIG. 17). These shear stress spikes were produced as the paddles moved across the shear stress sensors in this experimental setup. However, because the paddle stopped (intentionally) at different locations in the tank after each forward or backward cycle, the relationship between frequency of the spikes and paddle speed was slightly variable.

Instantaneous stress (defined as the typical value of the shear stress spikes) was related to the mean stress through a power relationship (Tᵢₙₛₜ=10.667×τₘₑₐₙ^{0.6916} R²=approximately 0.93) (FIG. 16D). Due to these high instantaneous bottom stresses, ratios of the standard deviations to the means were high and the shear stress distributions were peaked (high kurtosis) and positively skewed (not shown).

In the STURM tanks, it was the spikes in bottom shear stress that drove sediment resuspension. The mass eroded under stepwise increases of shear stress in an approximately 10 cm microcosm after an ecosystem experiment and sediment erosion data from annular flume erosion experiments on very similar natural sediments were compared to resuspension data from a STURM tank at approximately 12.5 RPM mixing speed at the end of an experiment. It is apparent from this that eroded mass from the STURM tanks compares quite well to the other data sets when expressed as a function of instantaneous stress but is an order of magnitude too high when expressed as a function of mean stress.

Volume-weighted RMS turbulent velocity in the STURM tanks increased with increasing mixing speed following a weakly quadratic 2nd degree polynomial curve and ranged from approximately 0.26 to approximately 4.5 cm s⁻ over mixing speeds from approximately 3.14 to approximately 37.7 RPM. Volume-weighted energy dissipation rate increased much more non-linearly with mixing speed and ranged from approximately 0.0016 to approximately 2.6 cm² s⁻³. For comparison, realistic water column mixing in nature includes RMS turbulent velocities ranging from about 0.1 to approximately 10 cm s⁻¹, and energy dissipation rates from about 10⁻⁶ to approximately 1 cm² s⁻³, with occasional higher values. Thus, the STURM RMS turbulent velocities were in the middle of the expected range, while the energy dissipation rates were slightly high but not unrealistic.

Local turbulence levels were highest near the tip of the large bar of the paddle, about half-way across the radius. Overall, RMS turbulent velocities and energy dissipation rates were lower within the water column than near the bottom, as observed in nature and as expected from boundary layer theory. Similar spatial distributions did not indicate the same turbulence generation mechanisms, however, since turbulence in the STURM tanks was generated by a paddle rotating just above the bottom while turbulence in natural boundary layers is generated by mean velocity shear that is strongest right at the bottom. Similar distributions did indicate that the STURM paddle and mixing designs reasonably mimic natural water column turbulence patterns. A secondary flow circulation cell resulted from the paddle motion, with the flow direction outward near the bottom, upward near the outside of the tank and downward in the center, which further homogenized the water column through large-scale stirring.

The stirring action is indicated in FIGS. 18A-I by advection of water flow upward along the walls, with low levels carried downward in the center. The flow cell (FIG. 18 G, H and I) was particularly evident at high mixing speeds. The result of this large scale stirring in the STURM tanks mimicked turbulent mixing of the water column by the largest eddies in natural boundary layer flows.

The ratio of RMS turbulent velocity and mean shear velocity is a measure of how well the benthic and the water column environments are matched. This ratio is about 1.4 in nature, and it was about 1.6 in a large linked mesocosm. The benthic and pelagic environments were not well connected in mesocosms with the same shape and size as the STURM tanks that used interior mixing paddles rather than benthic paddles; the ratio was 7.5 because of artificially low bottom shear. In the STURM systems, the ratio of RMS turbulent velocity to mean shear velocity increased from approximately 1.7 to approximately 3.6 over the range of mixing speeds (approximately 3.14 to approximately 37.7 RPM). The ratio of RMS turbulent velocity to the instantaneous spikes of shear velocity ranged from approximately 0.25 to approximately 1.05 over the same range.

The STURM tanks can be used for a wide range of comparative long-term ecosystem experiments with tidal or episodic resuspension of muddy sediments at different magnitudes or frequencies of resuspension, for short-term stepwise erosion experiments, or for experiments varying the frequency and magnitude of resuspension. Small-scale approaches can be implemented into these studies, such as geochemical flux experiments and erosion studies or particle studies. Moreover, the STURM tanks can be set up to provide a turbid environment so that the response of organisms to a varying magnitude, frequency and duration of turbidity can be tested.

The realistic scale and complexity of the contained ecosystems has revealed indirect feedbacks and responses that would not be observable in smaller, less complex experimental systems.

It has been found that regular tidal resuspension affected ecosystem structure and function profoundly, often through indirect pathways, and shifted processes from abenthic-dominated system to the water column by enhancing particulate and dissolved carbon and nutrient concentrations (inorganic nitrogen, nitrate+nitrite and soluble reactive phosphorus). Even though light was limiting in the STURM resuspension tanks, phytoplankton biomass was enhanced due to nutrient release from re-suspension. However, microphytobenthos biomass was significantly higher in non-resuspension mesocosms, mediated by lack of bottom shear and increased light. The dissolved inorganic nitrogen bio geo-chemical effluxes from the sediments, however, were similar between the STURM and non-resuspension tanks primarily due to higher benthic polychaetes and amphipod levels in the non-resuspension tanks. Moreover, blooms of brown tide (Aureococcus anophagefferens) occurred in the systems with tidal resuspension and not in the non-resuspension systems. This study demonstrated that tidal resuspension affected not only benthic-pelagic coupling rates, but also water column algal and zooplankton community composition through indirect and non-linear interactions.

Additionally, the presence of infaunal hard clams, Mercenaria mercenaria on these resuspension and non-resuspended systems was evaluated. In terms of mercury (Hg) dynamics, it was found that total Hg and MeHg was strongly bound to sediment particles with very little apparent release during the resuspension events. In the resuspension tanks, particulate Hg (nmol g⁻¹) was similar to that of the sediment but in the non-resuspension tanks, particulate Hg was lower. In contrast, particulate MeHg was significantly lower in the STURM tanks due to the presence of sediment particles with lower MeHg, which were dominant in the water column during resuspension events, as sediment % MeHg, typically <1%, is much lower than that of plankton (approximately 10-20%). However, over the course of the experiment, dissolved total Hg and MeHg did not change substantially in concert with changes in particulate load, as expected based on known partitioning behavior.

Sediment resuspension appeared to increase Hg methylation in the upper sediment compared to the non-resuspended mesocosms, and this likely reflects the impact of mixing on reducing the levels of sulfide in the sediment. Moreover, the bioaccumulation of MeHg in clams and zooplankton were comparable under conditions of different clam density (bioaccumulation factors, log BAF ˜2.3 for zooplankton; ˜6 for clams (dry weight basis)) were similar to those found in the environment.

These experiments also examined the interacting effects of shear stress and hard clams on seston, microphytobenthos, and nitrogen dynamics in STURM tanks with tidal resuspension in the presence and absence of hard clams. Phytoplankton abundance, microphytobenthos biomass, seston concentrations, and nitrogen dynamics were significantly affected by interactions between hard clams and bottom shear stress. The presence of hard clams initially destabilized the sediments with seston concentrations of about 200 mg L⁻¹ during tidal resuspension, but these decreased over time to being comparable to the tanks without clams (˜60 mg L⁻¹). The hard clams significantly reduced phytoplankton biomass and significantly enhanced nutrient concentrations due to higher resuspension and bivalve excretion. A brown tide (Aureococcus anophagefferens) bloom occurred in 2 of three STURM tanks with hard clams.

The system response at the approximately 6.2 RPM mixing setting is depicted FIGS. 16A and 16B, and FIGS. 18A and 18D. Immediately after the start of a 3 d resuspension event, large particles with average volume median diameters of approximately 140±14 eroded into the water column but as re-suspension approached steady state, flocs disaggregated and floc size decreased to approximately 112±3 μm. The duration of quiescence did not affect steady state floc size, though after longer intervals between resuspension events the larger flocs took longer to disaggregate. PCBs were released rapidly after resuspension started, but the duration of quiescence between resuspension events did not affect the total PCB release to the water column.

After mixing ceased, the large organic detritus settled first, leaving behind more fine-grained material. After approximately 60 min of settling, approximately 30% of the particles by mass still remained in the water column and this persisted even after approximately 19 h without mixing. Particles that remained suspended had significant amounts of PCBs which has significant implications for contaminant transport after a major environmental mixing event.

In LISST-based settling studies during ecosystem experiments with estuarine water and tidal resuspension, some particles similarly never settled out during the approximately 2 h quiescence periods.

These particle size changes, and the remnant “background” fraction that remains suspended for very long periods of time, are comparable to observations of in situ tidal resuspension and deposition.

Relatively large oceanographic instruments can also be used in the STURM tanks if their deployment is short-term (on the order of minutes to hours). Indeed, collection of these particle size distribution and concentration data during settling events after mixing was turned off was greatly facilitated through use of a field scale instrument, which was possible because of the size of the STURM tanks.

As apparent to those skilled in the art, resuspension is an important factor to consider in ecosystem experiments on benthic-pelagic coupling. Traditional mesocosms have unrealistic low bottom shear stress and do not satisfactorily resuspend sediments. Linked mesocosms are not able to include sediment resuspension in the experiments due to connecting lines potentially trapping sediment. The STURM systems as described herein can now include sufficiently high bottom shear stress to generate tidal and episodic resuspension as observed in nature, without undesirably overmixing the water column.

The instantaneous bottom shear stress appears to be a much better estimate of the stress responsible for resuspension in the STURM tanks than the mean stress. In many other erosion devices, flumes, and field studies, resuspension has been reported in terms of the mean shear stress although it is recognized that instantaneous shear stresses are randomly distributed about this mean. Indeed, coherent turbulent bursts of stress have been found to dominate sediment suspension in several studies. The short-lived maxima in shear stress as waves pass overhead also drive sediment resuspension, such that erosion thresholds developed for steady mean flows seem to most closely match thresholds based on wave maxima rather than a characteristic wave mean. Nevertheless, the fact that erosion levels induced by spikes in stress in the STURM tanks most closely match erosion levels relative to mean stresses in an annular flume and in microcosm erosion cores is insightful.

In the STURM tanks, the significant criteria were that resuspension and sediment-water exchanges can be realistically mimicked without undesirably over-mixing the systems to match mean stresses.

In the STURM systems only the top approximately 1-4 millimeters of sediment are resuspended whereas erosion depth is much less controllable and possibly unrealistic if equipment such as submersible pumps is used.

However, even though only a thin top layer of sediment is re-suspended in the STURM systems, it is likely that there is still a dynamic interaction between this surface layer and deeper sediments. In one experiment, a mercury isotope spike was added to the water column during the resuspension phase of a tidal resuspension experiment. The isotope spike was removed from the water column exponentially over time (half-life ˜1.3 days), suggesting its burial within the sediment. These results support the notion that different particles are resuspended during different tidal cycles, suggesting that there is dynamic mixing and burial of particles within the sediment. The rate of mercury isotope removal was similar for tanks with high and low densities of clams suggesting that the macrofauna were not the major mechanism for this burial.

It is desired to keep energy dissipation rates from becoming too high as energy dissipation rate is non-linearly related to RMS turbulent velocity (as described above). Energy dissipation rate controls small-scale fluid shear, so it can affect particle aggregation and disaggregation and planktonic contact rates; e.g., between copepods and their food particles. Thus, energy dissipation rate must be mimicked realistically in ecosystem experiments and in experiments with resuspension to allow the proper study of ecosystem processes and interactions.

Scaling the flow environments of the water column, the benthos, or both have previously often been mismatched. The STURM tanks, as described herein, address this mismatch directly and with success. The ratio of RMS turbulent velocity to mean shear velocity in nature is approximately 1.4. The ratio of RMS turbulent velocity to mean shear velocity in the STURM tanks increased from approximately 1.7 to approximately 3.6 over the full range of mixing speeds, but the ratio of RMS turbulent velocity to the instantaneous spikes of shear velocity responsible for bottom sediment resuspension ranged from approximately 0.25 to approximately 1.05 over the same range. Thus, the STURM systems bracket natural pelagic-benthic turbulence scaling in accordance with any mechanically stirred approximation of a natural environment and the benthos and the water column are directly coupled, as they are in nature.

The STURM tanks combine physics with ecology, and they can be used to examine biogeochemical processes such as the nutrient and contaminant cycling. With a 1 m³ volume, a 1 m² sediment surface area and a 1 m water column depth, the STURM tanks contain a large enough space/volume for self-design of communities and super-impose realistic fluid dynamics in the water column and at the sediment-water interface. Ecosystem experiments also can be of sufficient length to allow ecological self-organization. Thus, the STURM tanks are a unique example of an ecologically engineered experimental environment.

There are a number of alternate embodiments for the STURM systems described herein. For example, currently the STURM tank system utilizes two drive trains with three tanks each, set comparative treatments. However, the drive train can be expanded easily if more replicates are desired.

For example, the paddle height, or height of the resuspension mechanism, as described herein can be adjusted relative to the bottom of the resuspension tank and/or relative to the sediment layer. The resuspension mechanism (209) may have a threaded portion (211) in the shaft (210) to permit vertical length adjustments that correlate to an adjustment in the interaction between the lower portion (members 214, 216) relative to the sediment layer. The adjustment, using the threaded portion of the shaft (210) can be dynamically adjusted before the start of an ecosystem experiment and during an “off” period of the resuspension mechanism (paddle) movement, as described herein. Thus, the heights of the resuspension mechanism (209) can be set through adjustment, using threaded portions (211) of the shaft (210) and can be checked during ecosystem experiments. Use of a submerged video camera in the tank has been helpful to provide information on a desired height of the paddle. Based on the data and concepts described herein, particularly with respect to the relationship between paddle height and shear stress, as the resuspension height is raised, it is surmised that the shear stress will decrease. The exact relationship can be determined utilizing the parameters set forth herein.

While the described STURM ecosystem experiments have been performed at a relatively low end of the mixing settings in FIG. 17, at a mixing setting of 12.5 RPM. Additional mixing settings may also be used. Furthermore, while contaminant experiments were performed at a mixing setting of 6.1 RPM, this mixing setting may also be modified as contemplated herein. The set up tidal resuspension parameter using 4 h “mixing on” and 2 h “mixing off” cycles may also be modified, and it would be useful to keep the mixing conditions the same over a sampling period, although they could also vary.

The STURM software is set up such that any mixing cycle, written in an excel spreadsheet, can be input for tidal cycling. In addition to tidal cycling, episodic events can be dialed in such as storms for a wide variety of possible applications. Erosion experiments can be conducted in STURM systems, which is useful at the beginning of an ecosystem experiment. Oceanographic instruments such as LISST instruments or multiparameter sondes (e.g., YSI 6600) can be deployed in situ and smaller scale approaches, such as geochemical flux experiments or erosion devices can be implemented in a large-scale STURM ecosystem experiment for detailed process studies.

In the event that an indoor system is desired, light banks may be used. These may be positioned overhead to produce desired light energy. This desired light energy may be at least approximately 160 μE m⁻² s⁻¹ of photosynthetically active radiation at the water surface of the STURM tanks so that the experiment is not light limited.

For outdoor instantiations of the STURM tank system, care should be taken that the tanks are not significantly shaded by trees, buildings or the like during any part of the day. While the disclosed paddle design can be adapted to other tank sizes and shapes, the size and shape of the paddle disclosed herein has been found a good size for ecosystem experiments that is also not light limiting. If the shape changes and tanks used are narrower, care should be taken that light does not become limiting.

Various embodiments of the present disclosure are described herein and include examples of the present disclosure.

The embodiments described above and summarized below are combinable with one another in any permutation.

One embodiment is directed to a resuspension system, comprising a vessel having a predetermined volume of water contained in the vessel; and a resuspension mechanism disposed in the vessel configured to move in a pattern to produce water column mixing, an energy dissipation rate, and shear stress forces relative to a layer of sediment in a lower portion of the vessel, the layer of sediment having a predetermined depth. During a calibration process, the resuspension system further comprises a false-bottom plate including a plurality of flush-mounted shear stress sensors, each shear stress sensor having a sensor cable that is disposed underneath the false-bottom plate to reduce flow interference above the shear stress sensors

Another embodiment is directed to the resuspension system, where the paddle operates in a cyclic pattern, the pattern including moving in a first direction for a predetermined period of time, stopping for a predetermined period of time, moving in a second direction for a predetermined period of time, stopping for a predetermined period of time.

Yet another embodiment is directed to the resuspension system, where the paddle operates in a cyclic pattern, the cyclic pattern including moving in a forward direction for approximately 8 seconds, stopping for approximately 1.5 seconds, moving in a reverse direction for approximately 9 seconds, and stopping for approximately 1.5 seconds. This pattern is then repeated for four hours “on”, then two hours “off”, four hours “on”, two hours “off” etc.

Yet another embodiment is directed to the resuspension system, where the paddle is operated in an “on” operational status for approximately four hours and an “off” operational status for approximately two hours.

Yet another embodiment is directed to the resuspension system, where the paddle is operated in a predetermined mode for approximately four weeks.

Yet another embodiment is directed to the resuspension system, further comprising one or more motors operatively coupled to the paddle; one or more drive trains, operatively coupled to the motors; and one or more gear boxes operatively coupled to the drive trains.

Yet another embodiment is directed to the resuspension system, further comprising: one or more sensors configured to obtain vessel status data relating to conditions in the vessel; one or more processing devices operatively coupled to the sensors configured to receive the status data and process the status data; and one or more output devices operatively coupled to the one or more processing devices configured to display a representation of the status data.

Yet another embodiment is directed to the resuspension system, further comprising, where the status data comprises one or more of mixing data and turbidity data.

Yet another embodiment is directed to the resuspension, where the one or more sensors include optical backscatter sensors or turbidity sensors.

Yet another embodiment is directed to the resuspension system, further comprising one or more input devices configured to input a combination of predetermined bottom shear forces and turbulence parameters for the vessel.

Yet another embodiment is directed to the resuspension system, further comprising one or more input devices configured to input mixing settings for the vessel.

Yet another embodiment is directed to the resuspension system, where the vessel has an outer diameter of approximately 113 cm, a height of approximately 132 cm and a wall thickness of approximately 0.18 cm.

Yet another embodiment is directed to the resuspension system, where the predetermined volume of water contained in the vessel is approximately 1000 liters and has a one meter column height, the predetermined volume layer of sediment in the lower portion of the vessel has a surface area of approximately one square meter. Only the top approximately 1 mm of the sediment layer undergoes resuspension and deposition, however, a 10 cm deep sediment layer allows the taking of biogeochemical flux cores at the end of a STURM experiment. The sediment depth could vary depending on the application.

Yet another embodiment is directed to the resuspension system, where the resuspension mechanism is a paddle.

Yet another embodiment is directed to the resuspension system, where the paddle has a diameter of approximately 3.8 cm and is configured to span approximately one half a radius of the vessel.

Yet another embodiment is directed to the resuspension system, where the paddle comprises a first bar member and a second bar member affixed to a distal portion of the paddle having a gap between the first bar member and the second bar member.

Yet another embodiment is directed to the resuspension system, where the first bar member has a length dimension of approximately 7.6 cm and a height dimension of approximately 1.8 cm.

Yet another embodiment is directed to the resuspension system, where the second bar member has a length dimension of approximately 6.2 cm and a height dimension of approximately 1.2 cm.

Yet another embodiment is directed to the resuspension system, where the paddle includes a perforated plate and a silicone flap.

Yet another embodiment is directed to the resuspension system, further comprising: a filtration apparatus configured to filter at least a portion of the volume of water contained in the vessel.

Yet another embodiment is directed to the resuspension system, where the shear stress sensors include a first shear stress sensor disposed approximately 4.5 cm from a center of the vessel; a second shear stress sensor disposed approximately 13.5 cm from the center of the vessel; a third shear stress sensor disposed approximately 22.5 cm from the center of the vessel; a fourth shear stress sensor disposed approximately 31.5 cm from the center of the vessel; a fifth first shear stress sensor disposed approximately 40.5 cm from the center of the vessel; and a sixth shear stress sensor disposed approximately 49.5 cm from the center of the vessel.

Yet another embodiment is directed to the resuspension system, where instantaneous maximum bottom shear stress forces are between approximately 0.07 and 1.7 PA at a resuspension mechanism rotation of between approximately 3.14 and 37.7 RPM.

Yet another embodiment is directed to the resuspension system, where the energy dissipation rate is between approximately 0.0016 and 2.6 cm² s⁻³ at a resuspension mechanism rotation of between approximately 3.14 and 37.7 RPM.

Yet another embodiment is directed to the resuspension system, where a turbulence velocity parameter is measured across the tank radius and water column height.

Yet another embodiment is directed to the resuspension system, where a ratio of RMS turbulent velocity to mean shear velocity is between approximately 1.7 to 3.6 over a range of mixing speeds of the resuspension mechanism from between approximately 3.14 to 37.7 RPM.

Yet another embodiment is directed to the resuspension system, where the layer of sediment includes an aerobic component and an anaerobic component.

Yet another embodiment is directed to the resuspension system, where the resuspension mechanism resuspends a portion of the layer of sediment approximately 1 mm deep.

Yet another embodiment is directed to the resuspension system, where the resuspension mechanism produces an RMS turbulent velocity of between approximately 0.26 and 4.52 cms⁻¹.

Although the following detailed description contains many specifics for the purposes of illustration, anyone of ordinary skill in the art will appreciate that many variations and alterations to the following details are within the scope of the disclosure. Accordingly, the following embodiments are set forth without any loss of generality to, and without imposing limitations upon, the claims.

In this detailed description, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present disclosure.

Furthermore, in this detailed description, a person skilled in the art should note that quantitative qualifying terms such as “generally,” “substantially,” “mostly,” “approximately” and other terms are used, in general, to mean that the referred to object, characteristic, or quality constitutes a majority of the subject of the reference. The meaning of any of these terms is dependent upon the context within which it is used, and the meaning may be expressly modified.

Some of the illustrative embodiments of the present disclosure may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the disclosure has been described with reference to exemplary embodiments, it will be understood by those skilled in the art that various changes may be made and equivalents may be substituted for elements thereof without departing from the scope. In addition, many modifications may be made to adapt a particular situation or material to the teachings without departing from the essential scope thereof.

Therefore, it is intended that the disclosure not be limited to the particular embodiment disclosed as the best or only mode contemplated for carrying out this invention, but that the disclosure will include all embodiments falling within the scope of the appended claims. Also, in the drawings and the description, there have been disclosed exemplary embodiments and, although specific terms may have been employed, they are unless otherwise stated used in a generic and descriptive sense only and not for purposes of limitation, the scope of the disclosure therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the disclosure should be determined by the appended claims and their legal equivalents, and not by the examples given.

What is claimed is:

1. A resuspension system, comprising:
a vessel including a predetermined volume of water; and
a calibrated resuspension mechanism, disposed in the vessel, configured to move in a pattern to produce water column mixing, an energy dissipation rate, and shear stress forces relative to a layer of sediment in a lower portion of the vessel, the layer of sediment having a predetermined depth,
where, during a calibration process, the resuspension system further comprises a false-bottom plate including a plurality of flush-mounted shear stress sensors, each shear stress sensor having a sensor cable that is disposed underneath the false-bottom plate to reduce flow interference above the shear stress sensors.

2. The resuspension system of claim 1, where the resuspension mechanism is a paddle that operates in a cyclic pattern, the pattern including moving in a first direction for a predetermined period of time, stopping for a predetermined period of time, moving in a second direction for a predetermined period of time, stopping for a predetermined period of time.

3. The resuspension system of claim 1, where the resuspension mechanism is a paddle that operates in a cyclic pattern, the cyclic pattern including moving in a forward direction for approximately 8 seconds, stopping for approximately 1.5 seconds, moving in a reverse direction for approximately 9 seconds, and stopping for approximately 1.5 seconds.

4. The resuspension system of claim 1, where the resuspension mechanism is a paddle that is operated in an “on” operational status for approximately four hours and an “off” operational status for approximately two hours

5. The resuspension system of claim 1, where the resuspension mechanism is a paddle that is operated in a predetermined mode for approximately four weeks.

6. The resuspension system of claim 1, further comprising:
one or more motors operatively coupled to the resuspension mechanism;
one or more drive trains, operatively coupled to the motors; and
one or more gear boxes operatively coupled to the drive trains.

7. The resuspension system of claim 1, further comprising:
one or more sensors configured to obtain vessel status data relating to conditions in the vessel;
one or more processing devices operatively coupled to the sensors configured to receive the status data and process the status data; and
one or more output devices operatively coupled to the one or more processing devices configured to display a representation of the status data.

8. The resuspension system of claim 7, where the status data comprises one or more of mixing data and turbidity data.

9. The resuspension system of claim 7, where the one or more sensors include optical backscatter sensors or turbidity sensors.

10. The resuspension system of claim 7, further comprising one or more input devices configured to input a combination of predetermined bottom shear forces and turbulence parameter for the vessel.

11. The resuspension system of claim 7, further comprising one or more input devices configured to input mixing settings for the vessel.

12. The resuspension system of claim 1, where the vessel has an outer diameter of approximately 113 cm, a height of approximately 132 cm and a wall thickness of approximately 0.18 cm.

13. The resuspension system of claim 1, where the predetermined volume of water contained in the vessel is approximately 1000 liters and has approximately one meter column height, the predetermined volume layer of sediment in the lower portion of the vessel has a surface area of approximately one square meter.

14. The resuspension system of claim 1, where the resuspension mechanism is a paddle.

15. The resuspension system of claim 14, where the paddle has a diameter of approximately 3.8 cm and is configured to span approximately one half a radius of the vessel.

16. The resuspension system of claim 15 where the paddle comprises a first bar member and a second bar member affixed to a distal portion of the paddle having a gap between the first bar member and the second bar member.

17. The resuspension system of claim 16 where the first bar member has a length dimension of approximately 7.6 cm and a height dimension of approximately 1.8 cm.

18. The resuspension system of claim 16 where the second bar member has a length dimension of approximately 6.2 cm and a height dimension of approximately 1.2 cm.

19. The resuspension system of claim 14 where the paddle includes a perforated plate and a silicone flap.

20. The resuspension system of claim 1, further comprising: a filtration apparatus configured to filter at least a portion of the volume of water contained in the vessel.

21. The resuspension system of claim 1, where the shear stress sensors include:
a first shear stress sensor disposed approximately 4.5 cm from a center of the vessel;
a second shear stress sensor disposed approximately 13.5 cm from the center of the vessel;
a third shear stress sensor disposed approximately 22.5 cm from the center of the vessel;
a fourth shear stress sensor disposed approximately 31.5 cm from the center of the vessel;
a fifth first shear stress sensor disposed approximately 40.5 cm from the center of the vessel; and
a sixth shear stress sensor disposed approximately 49.5 cm from the center of the vessel.

22. The resuspension system of claim 1, where instantaneous maximum bottom shear stress forces are between approximately 0.07 and 1.7 PA at a resuspension mechanism rotation of between approximately 3.14 and 37.7 RPM.

23. The resuspension system of claim 1, where the energy dissipation rate is between approximately 0.0016 and 2.6 cm² s⁻³ at a resuspension mechanism rotation of between approximately 3.14 and 37.7 RPM.

24. The resuspension system of claim 1, where a turbulence velocity parameter is measured across a water column height.

25. The resuspension system of claim 1, where a ratio of RMS turbulent velocity to mean shear velocity is between approximately 1.7 to 3.6 over a range of mixing speeds of the resuspension mechanism from between approximately 3.14 to 37.7 RPM.

26. The resuspension system of claim 1, where the layer of sediment includes an aerobic component and an anaerobic component.

27. The resuspension system of claim 1, where the resuspension mechanism resuspends a portion of the layer of sediment approximately 1 mm deep.

28. The resuspension system of claim 1, where the resuspension mechanism produces an RMS turbulent velocity of between approximately 0.26 and 4.52 cms⁻¹.

29. The resuspension system of claim 1, where the resuspension mechanism includes:
a vertical shaft 210 guided on a central vertical pin attached to a bottom of the vessel;
a horizontal bar 212 having a proximal end, a lower surface and a distal end, the proximal end coupled to the vertical shaft 210;
a perforated plate 213 depending from the lower surface of the horizontal bar;
a flap 215 depending from the lower surface of the horizontal bar;
an extension rod 217 coupled to the distal end of the horizontal bar 212;
a first horizontal rod 214 coupled to the extension rod 217; and
a second horizontal rod 216 inwardly coupled to the first horizontal rod 214.
